(19) United States
(12) Patent Application Publication
(10) Pub. No.: US 2026/0369023 A1
(43) Pub. Date: Nov. 19, 2026

(54) Context-Based Bounding Box Selection

(71) Applicant: Google LLC, Mountain View, CA (US)

(72) Inventors: Lav Singh, Bengaluru (IN); Devansh Gautam, Bengaluru (IN); Aishwarya Mittal, Bengaluru (IN); Inderpreet Singh Saggu, Bengaluru (IN); Manish Arora, Bengaluru (IN); Nitish Krishna Murthy, Bengaluru (IN)

(21) Appl. No.: 19/219,668

(22) Filed: May 27, 2025

(30) Foreign Application Priority Data
May 14, 2025 (IN) 202511046379

(51) Int. Cl. G06V 10/25; G06V 20/70

(52) U.S. Cl. CPC G06V 10/25; G06V 20/70

(57) ABSTRACT

A computing system obtains an image depicting a plurality of objects, an object label associated with a particular object depicted in the image, and a ground truth bounding box associated with a position of the particular object within the image. The computing system processes the image, the object label, and the ground truth bounding box with a generative language model, which generates a plurality of synthetic text queries. Each synthetic text query references the particular object depicted in the image without using a term from the object label. The computing system generates a training example, which includes the image, the ground truth bounding box, and at least one of the plurality of synthetic text queries. The computing system includes multimodal region-of-interest (ROI) model, which is trained with the training example to determine one or more particular bounding boxes associated with the particular object depicted in the image.

### RELATED APPLICATIONS

The present application is based upon and claims the right of priority to Indian Provisional Patent Application No. 202511046379, filed on May 14, 2025, the disclosure of which is hereby incorporated by reference herein in its entirety for all purposes.

### FIELD

The present disclosure relates generally to machine learning processes and machine-learned devices and systems. More particularly, the present disclosure relates to enhancing a machine-learned model's ability to understand and process multimodal-based queries via the creation and use of synthetic training data.

### BACKGROUND

Understanding the world at large may be difficult. Whether an individual is trying to understand what the object in front of them is, trying to determine where else the object can be found, and/or trying to determine where an image on the internet was captured from, text searching alone may be difficult. In particular, users may struggle to determine which words to use. Additionally, the words may not be descriptive enough and/or abundant enough to generate desired results. In addition, the content being requested by the user may not be readily available to the user based on the user not knowing where to search, based on the storage location of the content, and/or based on the content not existing. The user may be requesting search results based on an imagined concept without a clear way to express the imagined concept.

### SUMMARY

Aspects and advantages of embodiments of the present disclosure will be set forth in part in the following description, or can be learned from the description, or can be learned through practice of the embodiments.

One example aspect of the present disclosure is directed to a method. The method includes obtaining, by a computing system comprising one or more processors, an image depicting a plurality of objects, an object label associated with a particular object of the plurality of objects depicted in the image, and a ground truth bounding box associated with a position of the particular object within the image. The method further includes processing, by the computing system, the image, the object label, and the ground truth bounding box with a generative language model to generate a plurality of synthetic text queries, each of the plurality of synthetic text queries referencing the particular object depicted in the image without using a term from the object label. The method further includes generating, by the computing system, a training example comprising the image, the ground truth bounding box, and at least one of the plurality of synthetic text queries. The method further includes training, by the computing system with the training example, a multimodal region-of-interest (ROI) model of the computing system to determine one or more particular bounding boxes associated with the particular object depicted in the image.

In some examples, training the multimodal ROI model of the computing system includes: processing, by the computing system, the image to generate a plurality of bounding boxes associated with the plurality of objects depicted in the image; processing, by the computing system, the image, the at least one of the plurality of synthetic text queries, and the plurality of bounding boxes to generate a plurality of probability scores associated with the plurality of bounding boxes; and adjusting, by the computing system, one or more parameters of the multimodal ROI model based on the plurality of probability scores and the ground truth bounding box.

In some examples, adjusting the one or more parameters of the multimodal ROI model includes: evaluating, by the computing system, a loss function based on a difference between one or more of the plurality of probability scores and the ground truth bounding box; and adjusting, by the computing system, the one or more parameters of the multimodal ROI model based on the loss function.

In some examples, the loss function includes a penalization term based on differences between the position of the particular object depicted in the image and respective positions of the plurality of objects associated with the plurality of bounding boxes.

In some examples, generating the training example includes: processing, by the computing system, the image and the plurality of synthetic text queries to generate a plurality of likelihood scores associated with the plurality of synthetic text queries, each of the plurality of likelihood scores being descriptive of a predicted likelihood that a respective synthetic text query is associated with one or more additional objects of the plurality of objects depicted in the image, the one or more additional objects being different objects relative to the particular object; and generating, by the computing system, the training example based on the plurality of likelihood scores.

In some examples, generating the training example based on the plurality of likelihood scores includes: determining, by the computing system based on the plurality of likelihood scores, that one or more particular synthetic text queries of the plurality of synthetic text queries are associated with the one or more additional objects depicted in the image; and processing, by the computing system, the plurality of synthetic text queries to generate one or more filtered synthetic text queries, the one or more filtered synthetic text queries corresponding to one or more of the plurality of synthetic text queries that are different from the one or more particular synthetic text queries.

In some examples, generating the training example based on the plurality of likelihood scores further includes generating, by the computing system, the training example comprising the image, the ground truth bounding box, and at least one of the one or more filtered synthetic text queries.

In some examples, processing the image, the object label, and the ground truth bounding box with the generative language model to generate the plurality of synthetic text queries includes processing, by the computing system, the image, the object label, and the ground truth bounding box with a chain-of-thought language model of the computing system to generate the plurality of synthetic text queries.

In some examples, the generative language model is prompted to generate one or more synthetic reference expressions based on one or more attributes of the ground truth bounding box, and the one or more synthetic reference expressions include one or more terms that are different relative to the term from the object label.

In some examples, the generative language model is trained using chain-of-thought prompting.

In some examples, the generative language model is a pre-trained vision language model.

In some examples, the multimodal ROI model is a multitask unified model (MUM).

Another example aspect of the present disclosure is directed to a computing system. The computing system includes one or more processors. The computing system further includes one or more non-transitory computer-readable media that collectively store instructions that, when executed by the one or more processors, cause the computing system to perform operations. The operations include receiving a multimodal search query comprising an image depicting a plurality of objects and a text query corresponding to one or more particular objects of the plurality of objects depicted in the image. The operations further include determining, by an object detection model, a plurality of bounding boxes for the image of the multimodal search query, each bounding box respectively identifying at least one of the plurality of objects depicted in the image. The operations further include processing, by a multimodal region-of-interest (ROI) model, the multimodal search query and the plurality of bounding boxes to generate a plurality of likelihood scores associated with the plurality of bounding boxes, each of the plurality of likelihood scores being descriptive of a predicted likelihood that a respective bounding box of the plurality of bounding boxes is associated with the text query. The operations further include determining one or more particular bounding boxes are associated with the one or more particular objects. The operations further include determining, by a search engine, a plurality of search results based on the multimodal search query and the one or more particular bounding boxes.

In some examples, to process the multimodal search query and the plurality of bounding boxes to generate the plurality of likelihood scores associated with the plurality of bounding boxes, the operations includes, for each bounding box of the plurality of bounding boxes: processing, by the multimodal ROI model, the multimodal search query to generate one or more multimodal embeddings; processing, by the multimodal ROI model, the bounding box to generate one or more bounding box embeddings; processing, by the multimodal ROI model, the one or more multimodal embeddings and the one or more bounding box embeddings to determine a descriptive relationship between the text query of the multimodal search query and the bounding box; and generating a likelihood score for the bounding box based on the descriptive relationship between the bounding box and the text query of the multimodal search query.

In some examples, to determine the one or more particular bounding boxes are associated with the one or more particular objects, the operations include: processing, by the multimodal ROI model, the plurality of likelihood scores associated with the plurality of bounding boxes to generate a ranked bounding box list, the ranked bounding box list comprising the plurality of bounding boxes ordered based on the plurality likelihood scores; and determining one or more particular bounding boxes of the plurality of bounding boxes of the ranked bounding box list are associated with the one or more particular objects based on the plurality of likelihood scores.

In some examples, the multimodal ROI model is trained to determine whether the one or more particular bounding boxes are associated with the one or more particular objects based on training data generated by a generative language model.

In some examples, the generative language model includes a pre-trained vision language model.

In some examples, the multimodal ROI model includes a multitask unified model (MUM).

In some examples, to determine the plurality of bounding boxes for the image of the multimodal search query, the operations include: receiving, by the object detection model, the image of the multimodal search query; processing, by the object detection model, the image of the multimodal search query to identify the plurality of objects depicted in the image; and generating, by the object detection model, at least one bounding box identifying each object of the plurality of objects depicted in the image.

Another example aspect of the present disclosure is directed to one or more non-transitory computer-readable media that collectively store instructions that, when executed by one or more processors of a computing system, cause the computing system to perform operations. The operations include: obtaining an image depicting a plurality of objects, an object label associated with a particular object of the plurality of objects depicted in the image, and a ground truth bounding box associated with a position of the particular object within the image; processing the image, the object label, and the ground truth bounding box with a vision language model to generate a plurality of synthetic text queries, each of the plurality of synthetic text queries referencing the particular object depicted in the image without using a term from the object label; generating a training example comprising the image, the ground truth bounding box, and at least one of the plurality of synthetic text queries; and training, with the training example, a multimodal region-of-interest (ROI) model of the computing system to determine one or more particular bounding boxes associated with the particular object depicted in the image.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example augmented query generation system according to example embodiments of the present disclosure;

FIG. 2 depicts a block diagram of an example multimodal model tuning system according to example embodiments of the present disclosure;

FIG. 3 depicts a flow chart diagram of an example method for generating augmented query output data according to example embodiments of the present disclosure;

FIG. 4A-4C depict illustrative examples of multimodal input data according to example embodiments of the present disclosure;

FIG. 5 depicts an illustrative block diagram of an example multimodal region-of-interest (ROI) model according to example embodiments of the present disclosure;

FIG. 6 depicts a flow chart diagram of an example method for implementing a multimodal query-based search according to example embodiments of the present disclosure;

FIG. 7 depicts a block diagram of an example training example generation system according to example embodiments of the present disclosure;

FIG. 8 depicts an illustrative sequence of generating a training example according to example embodiments of the present disclosure;

FIG. 9A-9B depict flow chart diagrams of an example method for training a multimodal region-of-interest (ROI) model according to example embodiments of the present disclosure;

FIG. 10A-10B depict block diagrams of an example computing system according to example embodiments of the present disclosure;

FIG. 11 depicts a flow chart diagram illustrating an example method for training a machine-learned model according to example embodiments of the present disclosure;

FIG. 12 depicts a block diagram of an example processing flow for using machine-learned model(s) to process input(s) to generate output(s) according to example embodiments of the present disclosure;

FIG. 13 depicts a block diagram of an example sequence processing model according to example embodiments of the present disclosure;

FIG. 14 depicts a block diagram of an example technique for populating an example input sequence for processing by a sequence processing model according to example embodiments of the present disclosure;

FIG. 15 depicts a block diagram of an example model development platform according to example embodiments of the present disclosure;

FIG. 16 depicts a block diagram of an example training workflow for training a machine-learned model according to example embodiments of the present disclosure;

FIG. 17 depicts a block diagram of an inference system for operating one or more machine-learned model(s) to perform inference according to example embodiments of the present disclosure;

FIG. 18 depicts a block diagram of an example networked computing system according to example embodiments of the present disclosure;

FIG. 19 depicts a block diagram of an example computing device according to example embodiments of the present disclosure; and

FIG. 20 depicts a block diagram of an example computing device a according to example embodiments of the present disclosure.

Repeat use of reference characters in the present specification and drawings is intended to represent the same and/or analogous features or elements of the present invention.

### DETAILED DESCRIPTION

Generally, the present disclosure is directed to systems and methods for identifying discrete regions-of-interest within images based on complex, multimodal search queries. In particular, a computing system of the present disclosure may receive and/or obtain a multimodal search query, which includes an image and a corresponding text query. The computing system may process the multimodal search query to determine and/or identify one or more discrete regions-of-interest within the image based on attributes of the corresponding text query. The computing system may then leverage a search engine to determine and/or obtain search results based on and/or corresponding to the discrete regions-of-interest within the image.

Multimodal searching (e.g., queries with both text data and image data) is becoming increasingly popular amongst users. As such, when a user initiates a multimodal search, users expect search systems to understand which portions of the image the textual query is referring to. Existing search systems can suffer from the same and/or similar limitations when it comes to resolving multimodal search queries—namely, the misidentification of regions-of-interest within images based on the corresponding textual query. For instance, existing search systems may struggle with the identification process and/or may merely process the entire image without text-based conditioning. This limitation can directly affect the accuracy and/or relevance of the search results output by the search system.

Accordingly, example aspects of the present disclosure provide systems and methods for generating multimodal training data (e.g., training examples) based on multimodal input data (e.g., image, object label, ground truth bounding box) that may be utilized to train a multimodal ROI model to determine and/or identify particular objects within an image based on a corresponding text query, which, as described in greater detail below, can then be utilized to process multimodal queries to generate a refined query (e.g., multimodal query having an image, a text string, and a segmented portion of the image associated with a bounding box determined to be associated with the text string). More particularly, an image, a bounding box, and an object label may be processed with a generative model, such as a Large Language Model (LLM) (e.g., a Large Multimodal Model (LMM), which may include a vision language model), to generate example queries (e.g., synthetic text queries) associated with the particular object within the bounding box without including the object's name. The example queries may be filtered to remove any query that may be interpreted as referring to multiple different objects and/or features of the image. The remaining example queries (e.g., following filtering) may then be used as training examples to train a multimodal ROI model, such as a multitask unified model (MUM).

In some examples, a training example may include an image, a filtered synthetic text query that indirectly references a particular object depicted in the image, and/or a ground truth bounding box associated with a position of the particular object within the image. The computing system may process the training example to determine one or more particular bounding boxes associated with a position of the particular object depicted in the image. The particular bounding box(es) may be utilized by the computing system to evaluate a loss function and, based on the loss function, adjust one or more parameters of the multimodal ROI model.

The trained multimodal ROI model can then be utilized by a search system to process and understand multimodal queries. For example, the search system can obtain a multimodal query that includes an image and a text string. An object detection model can process the image to generate a plurality of bounding boxes and/or a plurality of image segments, in which each bounding box and/or each image segment is associated with a different object depicted in the image. The trained multimodal ROI model can process the plurality of bounding boxes and/or the plurality of image segments and the text string to determine which of the plurality of bounding boxes and/or the plurality of image segments is associated with the text string. Based on the output of the multimodal ROI model, the search system may generate one or more refined multimodal queries in which the one or more refined multimodal queries may include the text string and a segmented portion of the image associated with a bounding box determined to be associated with the text string (e.g., an image segment generated with an image segmentation model that segments the portion of the image based on the bounding box). In some implementations, the refined multimodal query may include the text string, the image, and the bounding box with the highest probability score. The one or more refined multimodal queries may then be searched via a search engine to determine a plurality of search results.

By utilizing the trained multimodal ROI model, the search system can identify relevant portions of an image query, which can be utilized to segment the relevant portions to generate a multimodal query that is more directed at addressing the question provided by the text string. The refined query can improve results by ensuring that search results are not retrieved based on other features within the image. Additionally and/or alternatively, the refined query may be smaller than the initial multimodal query, which can reduce the transmittal cost and the computational cost of the search processing.

The systems and methods described herein provide a number of technical effects and benefits, including improvements to computing technology. As one example, the systems and methods described herein may be utilized to tune a multimodal ROI model, such as a MUM, to improve region-of-interest identification based on complex, multimodal text queries. In particular, the systems and methods described herein may leverage a generative language model to generate synthetic text queries, which may be subsequently processed as by the multimodal ROI model as training data. By generating synthetic text queries that indirectly refer to a particular object within an image, a ground truth bounding box corresponding to a position of the particular object may be utilized to evaluate a loss function, and one or more parameters of the multimodal ROI model may then be adjusted based on the loss function. In this way, example aspects of the present disclosure are operable to tune the multimodal ROI model to determine relevant bounding boxes (e.g., regions-of-interest) for multimodal search queries, thereby providing improvements to multimodal processing and searching. As another example, example aspects of the present disclosure may leverage super-lightweight generative models to generate the synthetic text queries. In some examples, the generative models may be orders of magnitude faster than existing models.

Furthermore, example aspects of the present disclosure may also improve the accuracy and/or relevancy of search results based on multimodal search queries. More particularly, computing systems of the present disclosure may process multimodal search queries to determine a relevant portion of an image that is associated with a corresponding text query. In this way, the image may be segmented before search processing without labeling the detected objects (e.g., in the image), thereby improving the relevancy and/or accuracy of search results based on the multimodal search query.

In addition to the search results-based benefits described above, image segmenting prior to search processing without labeling detected objects in an image may further provide technical benefits related to improved computational efficiency and improvements in the functioning of the computing system as a whole. For instance, by improving the accuracy and/or relevancy of corresponding search results, the computing system may receive a reduced volume of follow-up queries, which may reduce search engine computational costs.

As another example, example aspects of the present disclosure further provide an ability to reduce the computational resources needed for training and/or tuning a multimodal ROI model to determine relevant bounding boxes for multimodal search queries. For instance, by leveraging a generative language model to generate synthetic training examples, computational resource requirements associated with obtaining, processing, and storing a robust set of training data may be greatly reduced.

Various example implementations are described herein with respect to the accompanying Figures.

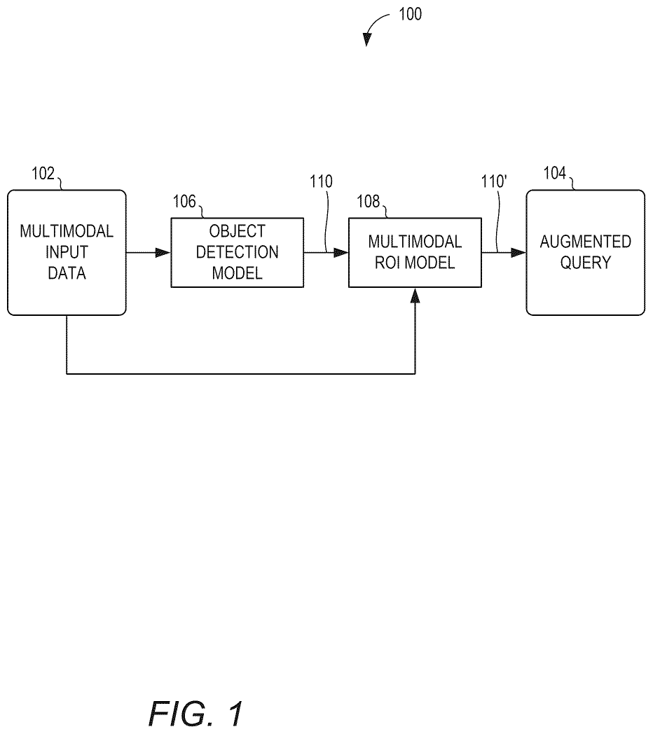

FIG. 1 depicts a block diagram of an example augmented query generation system 100 according to example embodiments of the present disclosure. Each component of the augmented query generation system 100 may be implemented using hardware, software, and/or a combination thereof. In some examples, the augmented query generation system 100 is configured to receive, and/or obtain, a set of multimodal input data 102 descriptive of a particular object depicted in an image and, as a result of receipt of the multimodal input data 102, generate, determine, and/or provide augmented query output data 104 that includes a cropped (e.g., partial) portion of the image depicting the particular object. Thus, in some examples, the augmented query generation system 100 may include an object detection model 106 that is operable to detect each object in the image and generate a corresponding bounding box; the augmented query generation system 100 may further include a multimodal region-of-interest (ROI) model 108 that is operable to process the multimodal input data 102 and determine a predicted likelihood that a respective bounding box (e.g., determined by the object detection model 106) is associated with the particular object.

More particularly, a computing system, such as the augmented query generation system 100, may receive and/or otherwise obtain the multimodal input data 102. The multimodal input data 102 may include an image depicting a plurality of objects, scenes, and/or other features. The image may be any suitable visual representation, such as, by way of non-limiting example, a photograph, diagram, and/or any other form of image data, including video.

The multimodal input data 102 may further include a text input corresponding to one or more particular objects, scenes, features, etc., depicted in the image. That is, the text input may include a reference expression that is descriptive of one or more particular objects, scenes, features, etc., depicted in the image. In some examples, the text input may include a direct reference expression, which includes one or more terms that directly refer to a particular object, scene, feature, etc., depicted in the image. Additionally and/or alternatively, in some examples, the text input may include an indirect reference expression, which includes one or more terms that indirectly refer to a particular object, scene, feature, etc., depicted in the image. Additionally and/or alternatively, in some examples, the text input may include a spatial reference expression, which includes one or more terms that identify a position (e.g., spatial location) of a particular object, scene, feature, etc., depicted in the image with respect to other objects, scenes, features, etc., depicted in the image.

The object detection model 106 may process the multimodal input data 102 to identify each object, scene, feature, etc., depicted in the image. More particularly, the object detection model 106 may be operable to generate one or more object detections 110, such as one or more bounding boxes, that identify regions in the image in which an object, scene, feature, etc., is depicted. For instance, in some examples, the object detection model 106 may be operable to determine a plurality of bounding boxes for the image of the multimodal input data 102, each of which respectively identifying at least one of the plurality of objects, scenes, features, etc., depicted in the image.

As described herein, the multimodal ROI model 108 may be operable to resolve complex, multimodal queries by implementing a multidirectional analysis of the input query to understand a true intent of the input query. The multimodal ROI model 108 may be built on transformer architecture and may implement a T5 text-to-text framework, which converts natural language processing tasks into a text-to-text format. The multimodal ROI model 108 may be trained using a plurality of different languages, thereby making the multimodal ROI model 108 multilingual. In some examples, the multimodal ROI model 108 may receive a multimodal query (e.g., image, text) and may embed the multimodal query with image bounding box(es) in the same embedding space. The systems and methods disclosed herein can be utilized to configure and/or fine-tune a pre-trained multitask unified model for multimodal processing to generate relevancy probability scores, which may be utilized as part of the multimodal ROI model 108.

More particularly, the multimodal ROI model 108 may process the multimodal input data 102 and the one or more object detections 110 (e.g., generated by the object detection model 106) to determine one or more particular object detections 110′ are associated with the particular object, scene, feature, etc., associated with the text input of the multimodal input data 102. More particularly, in some examples, the multimodal ROI model 108 may process the multimodal input data 102 and the one or more object detections 110 to generate a plurality of object scores (e.g., likelihood scores) associated with the one or more object detections 110. Each object score may be descriptive of a predicted likelihood that a respective object detection 110 is associated with the multimodal input data 102 (e.g., text input). In such examples, the one or more particular object detections 110′ may be determined based on the respective object scores associated with the one or more object detections 110.

The augmented query generation system 100 may then generate, determine, and/or provide the augmented query output data 104 based on the one or more particular object detections 110′. More particularly, the augmented query generation system 100 may determine and/or identify a particular portion of the image depicting the particular object based on the one or more particular object detections 110′. The augmented query generation system 100 may then generate the augmented query output data 104, which includes a cropped (e.g., partial) portion of the image that corresponds to the particular portion of the image depicting the particular object.

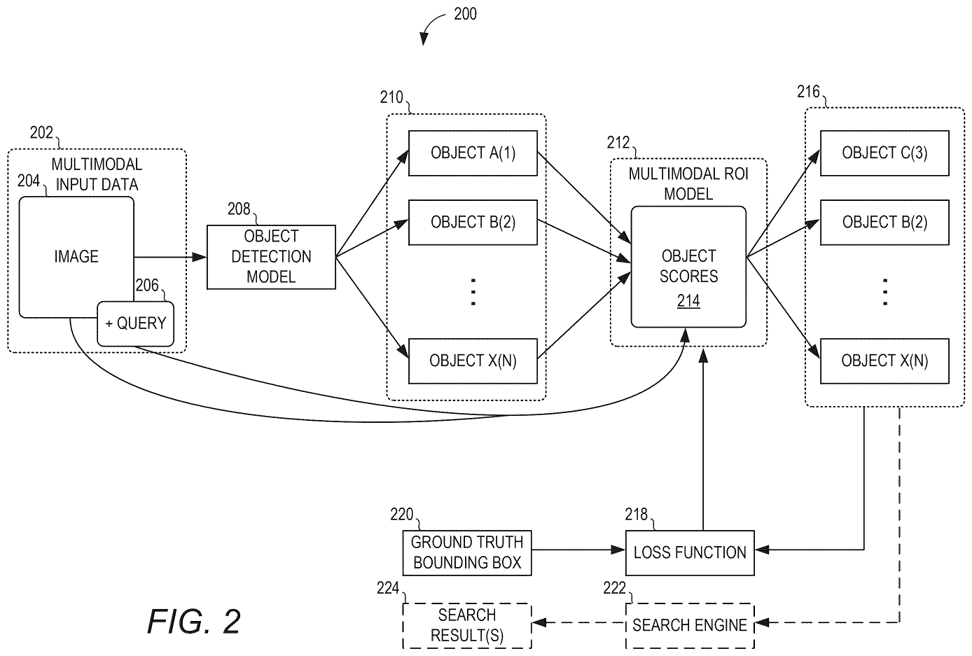

FIG. 2 depicts a block diagram of an example multimodal model tuning system 200 according to example embodiments of the present disclosure. The multimodal model tuning system 200 is similar to the augmented query generation system 100 described above with reference to FIG. 1 except that the multimodal model tuning system 200 includes object detection model 208 and multimodal ROI model 212. As discussed in greater detail below, the multimodal model tuning system 200 may further include a loss function 218, which can be utilized to tune one or more parameters of the multimodal ROI model 212.

The multimodal model tuning system 200 may receive and/or otherwise obtain multimodal input data 202. The multimodal input data 202 may include image data, text data, audio data, latent encoding data, metadata, and/or other data. More particularly, the multimodal input data 202 may include an image 204 and a text query 206. The image 204 may depict a plurality of objects. The text query 206 may include text data, such as one or more terms (e.g., words, etc.), corresponding to one or more particular objects of the plurality of objects depicted in the image 204.

The multimodal model tuning system 200 may include an object detection model 208. The multimodal model tuning system 200 may process the image 204 of the multimodal input data 202 with the object detection model 208. The object detection model 208 may determine a plurality of bounding boxes 210-1-210-N (generally, bounding box(es) 210) for the image 204 of the multimodal input data 202. Each bounding box 210 may respectively identify at least one of the plurality of objects depicted in the image 204. More particularly, in some examples, the object detection model 208 may receive the image 204 of the multimodal input data 202, process the image 204 of the multimodal input data 202 to identify the plurality of objects depicted in the image 204, and generate at least one bounding box 210 identifying each object of the plurality of objects depicted in the image 204.

The multimodal model tuning system 200 may include a multimodal region-of-interest (ROI) model 212. In some examples, the multimodal ROI model 212 includes a multitask unified model (MUM). More particularly, a “multitask unified model” or “MUM” can refer to a machine-learned model that is operable to simultaneously handle multiple different tasks by leveraging its multilingual, multimodal, and deep understanding capabilities. For instance, the multimodal ROI model 212 may be trained across multiple different tasks, which allows the multimodal ROI model 212 to develop a more comprehensive understanding of information and world knowledge relative to other machine-learned models. Additionally, the multimodal ROI model 212 may also be operable as a generative model and, as such, may be configured to produce generative output data. Furthermore, the multimodal ROI model 212 is a multimodal model and, hence, is operable to understand input data across various different modalities, such as image data, text data, audio data, video data, and/or the like.

The multimodal ROI model 212 may process the multimodal input data 202 (e.g., image 204, text query 206) and the plurality of bounding boxes 210 (e.g., determined by the object detection model 208) to generate a plurality of object scores 214 associated with the plurality of bounding boxes 210. Each object score 214 may be descriptive of a predicted likelihood (e.g., predicted probability) that a respective bounding box 210 is associated with the text query 206.

More particularly, in some examples, the multimodal ROI model 212 may receive and/or otherwise the multimodal input data 202 (e.g., image 204, text query 206). The multimodal ROI model 212 may process the multimodal input data 202 to generate one or more multimodal embeddings. The multimodal ROI model 212 may also receive and/or otherwise obtain each bounding box 210 determined by the object detection model 208. The multimodal ROI model 212 may process each bounding box 210 to generate one or more bounding box embeddings. The multimodal ROI model 212 may process the multimodal embeddings and the one or more bounding box embeddings to determine a descriptive relationship between the text query 206 of the multimodal input data 202 and each bounding box 210. The multimodal model tuning system 200 may generate an object score 214 for each bounding box 210 based on the descriptive relationship between the respective bounding box 210 and the text query 206 of the multimodal input data 202.

The multimodal model tuning system 200 may determine one or more particular bounding boxes (e.g., of the plurality of bounding boxes 210) are associated with the one or more particular objects depicted in the image 204.

More particularly, in some examples, the multimodal ROI model 212 may process the plurality of object scores 214 associated with the plurality of bounding boxes 210 to generate a ranked bounding box list 216. The ranked bounding box list 216 may include the plurality of bounding boxes 210 ordered based on the plurality object scores 214. The multimodal tuning system 200 may determine one or more particular bounding boxes (e.g., of the plurality of bounding boxes 210) of the ranked bounding box list 216 are associated with the one or more particular objects (e.g., of the plurality of objects depicted in the image 204) based on the plurality of object scores 214.

In some examples, the multimodal model tuning system 200 may implement a training process to tune one or more parameters of the multimodal ROI model 212. More particularly, in such examples, the multimodal model tuning system 200 may also evaluate a loss function 218 based at least in part on the multimodal input data 202 and the ranked bounding box list 216 to tune one or more parameters of the multimodal ROI model 212. For instance, in some examples, the multimodal input data 202 may further include a ground truth bounding box 220. The ground truth bounding box 220 may be one or more bounding boxes that are associated with a respective position of the one or more particular objects depicted in the image 204 that are referenced by the text query 206.

The loss function 218 may be evaluated based on a difference between each bounding box 210 of the ranked bounding box list 216 (e.g., one or more of the plurality of object scores 214 respectively associated with each of the plurality of bounding boxes 210) and the ground truth bounding box 220. More particularly, the loss function 218 may generate a gradient descent based on comparing the bounding boxes 210 of the ranked bounding box list 216 and the ground truth bounding box 220. In some examples, the loss function 218 may include penalization terms based on differences between the position of the particular object depicted in the image 204 and respective positions of the plurality of objects associated with the plurality of bounding boxes 210.

One or more parameters of the multimodal ROI model 212 may then be adjusted based on the loss function 218. For instance, the gradient descent may be backpropagated to the multimodal ROI model 212 to tune weights of the multimodal ROI model 212 for query-based bounding box selection. The process may be iteratively performed to tune the multimodal ROI model 212 to determine whether the one or more particular bounding boxes (e.g., of the plurality of bounding boxes 210) are associated with the one or more particular objects (e.g., of the plurality of objects depicted in the image 204) based on the ranked bounding box list 216.

Additionally and/or alternatively, in some examples, the multimodal model tuning system 200 may provide the multimodal input data 202 (e.g., image 204, text query 206) and the one or more particular bounding boxes (e.g., of the plurality of bounding boxes 210) to a search engine 222. The search engine 222 may determine a plurality of search results 224 based on the multimodal input data 202 and the one or more particular bounding boxes (e.g., of the plurality of bounding boxes 210) associated with the one or more particular objects (e.g., of the plurality of objects depicted in the image 204).

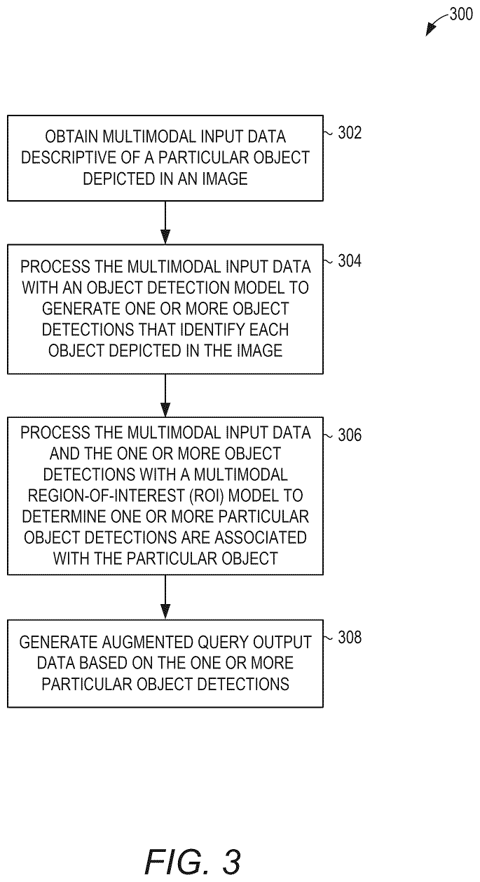

FIG. 3 depicts a flow chart diagram of an example method 300 for generating augmented query output data according to example embodiments of the present disclosure. FIG. 3 depicts steps performed in a particular order for purposes of illustration and discussion. Those having ordinary skill in the art, using the disclosures provided herein, will understand that various steps of any of the methods described herein may be omitted, expanded, performed simultaneously, rearranged, and/or modified in various ways without deviating from the scope of the present disclosure. Furthermore, various steps (not illustrated) may be performed without deviating from the scope of the present disclosure.

Referring to FIG. 3 at (302), the computing system may obtain multimodal input data descriptive of a particular object depicted in an image. The multimodal input data may include an image depicting a plurality of objects. The image may be any suitable visual representation, such as, by way of non-limiting example, a photograph, diagram, and/or any other form of image data, including video. The multimodal input data may further include a text input corresponding to one or more particular objects depicted in the image. That is, the text input may include a reference expression that is descriptive of one or more particular objects depicted in the image. In some examples, the text input may include a direct reference expression, which includes one or more terms that directly refer to a particular object depicted in the image. Additionally and/or alternatively, in some examples, the text input may include an indirect reference expression, which includes one or more terms that indirectly refer to a particular object depicted in the image. Additionally and/or alternatively, in some examples, the text input may include a spatial reference expression, which includes one or more terms that identify a position (e.g., spatial location) of a particular object depicted in the image with respect to other objects depicted in the image.

At (304), the computing system may process the multimodal input data with an object detection model to generate one or more object detections that identify each object depicted in the image. More particularly, the object detection model may be operable to generate one or more object detections, such as one or more bounding boxes, that identify regions in the image in which an object is depicted. For instance, in some examples, the object detection model may be operable to determine a plurality of bounding boxes for the image of the multimodal input data, each of which respectively identifying at least one of the plurality of objects depicted in the image.

At (306), the computing system may process the multimodal input data and the one or more object detections with a multimodal region-of-interest (ROI) model to determine one or more particular object detections are associated with the particular object. More particularly, the multimodal ROI model may process the multimodal input data and the one or more object detections (e.g., generated by the object detection model) to determine one or more particular object detections are associated with the particular object associated with the text input of the multimodal input data. More particularly, in some examples, the multimodal ROI model may process the multimodal input data and the one or more object detections to generate a plurality of object scores (e.g., likelihood scores) associated with the one or more object detections. Each object score may be descriptive of a predicted likelihood that a respective object detection is associated with the multimodal input data (e.g., text input). In such examples, the one or more particular object detections may be determined based on the respective object scores associated with the one or more object detections.

At (308), the computing system may generate augmented query output data based on the one or more particular object detections. More particularly, the computing system may then generate, determine, and/or provide the augmented query output data based on the one or more particular object detections. For instance, the computing system may determine and/or identify a particular portion of the image depicting the particular object based on the one or more particular object detections. The computing system may then generate the augmented query output data, which may include a cropped (e.g., partial) portion of the image that corresponds to the particular portion of the image depicting the particular object.

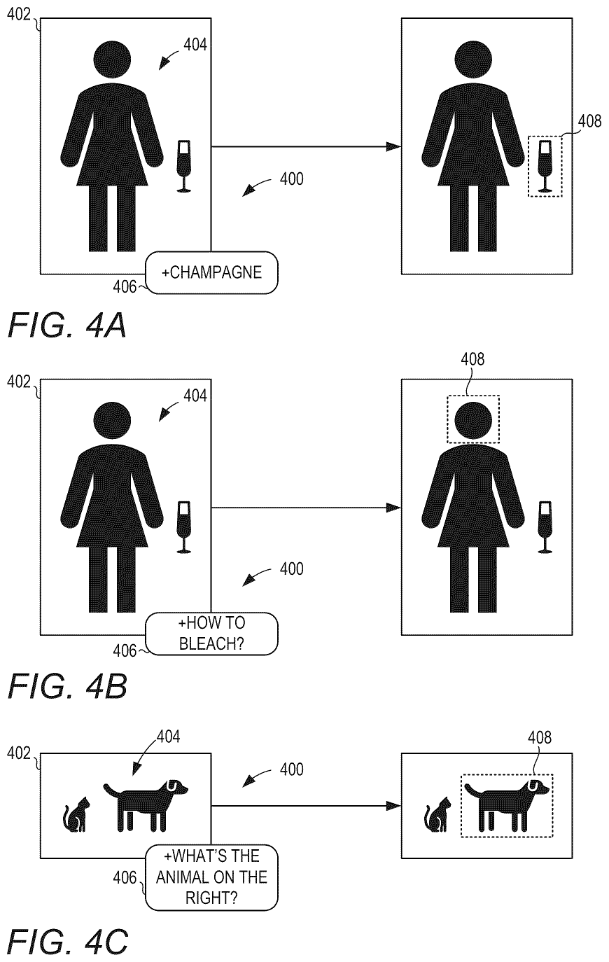

FIG. 4A-4C depict illustrative examples of multimodal input data 400 according to example embodiments of the present disclosure. As described herein, the multimodal input data 400 may include an image 402. The image 402 may be any suitable visual representation depicting a plurality of objects 404, such as, by way of non-limiting example, a photograph, diagram, and/or other form of image data, including video. The multimodal input data 400 may further include a text input 406. The text input 406 may correspond to one or more particular objects 408 depicted in the image 402. More particularly, the text input 406 may include a reference expression that is descriptive of the one or more particular objects 408 depicted in the image 402.

In some examples, the text input 406 may include a direct reference expression. For instance, as shown in FIG. 4A, the text input 406 includes a direct reference expression with one or more terms (e.g., “CHAMPAGNE”) that directly refers to the particular object 408 (e.g., champagne glass) depicted in the image 402. Additionally and/or alternatively, in some examples, the text input 406 may include an indirect reference expression. For instance, as shown in FIG. 4B, the text input 406 includes an indirect reference expression with one or more terms (e.g., “HOW TO BLEACH?”) that indirectly refer to the particular object 408 (e.g., hair) depicted in the image 402. Additionally and/or alternatively, in some examples, the text input 406 may include a spatial reference expression. For instance, as shown in FIG. 4C, the text input 406 includes a spatial reference expression with one or more terms (e.g., “WHAT IS THE ANIMAL ON THE RIGHT?”) that identify a position (e.g., right side) of the particular object 408 (e.g., dog) depicted in the image with respect to other objects 404 (e.g., cat) depicted in the image 402.

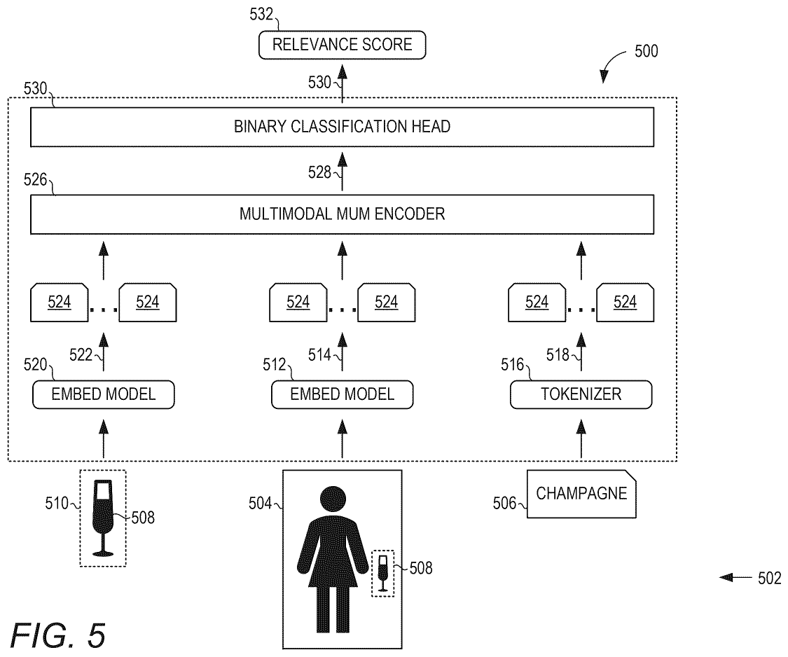

FIG. 5 depicts an illustrative block diagram of an example multimodal region-of-interest (ROI) model 500 according to example embodiments of the present disclosure. The multimodal ROI model 500 may be similar to any of the multimodal ROI models described herein, such as, by way of non-limiting example, the multimodal ROI model 108 (FIG. 1), the multimodal ROI model 212 (FIG. 2), and/or the like. As described herein, the multimodal ROI model 500 may be trained to determine whether a particular bounding box is associated with a particular object depicted in an image based on a reference expression in a corresponding text query.

As an illustrative example, the multimodal ROI model 500 may receive and/or may otherwise obtain input data 502. The input data 502 may include an image 504 depicting one or more objects and an object label 506 associated with a particular object 508 depicted in the image 504. The input data 502 may further include a bounding box 510 identifying at least one object (e.g., the particular object 508) depicted in the image 504. In some examples, the multimodal ROI model 500 may receive and/or may otherwise obtain the bounding box 510 from an object detection model that is configured to identify each object depicted in the image 510.

The multimodal ROI model 500 may then process the input data 502 to generate one or more input embeddings. More particularly, the multimodal ROI model 500 may process the image 504 with an image embedding model 512, which may generate an image embedding 514 associated with the image 502. The multimodal ROI model 500 may process the object label 506 with a tokenizer 516 and/or a textual embedding model, which may generate an object label embedding 518 associated with the object label 506. The multimodal ROI model 500 may process the bounding box 510 with a bounding box embedding model 520, which may generate a bounding box embedding 522 associated with the bounding box 510.

The multimodal ROI model 500 may pass the embeddings (e.g., image embedding 514, object label embedding 518, bounding box embedding 522) through respective processing nodes 524. Subsequently, the multimodal ROI model 500 may process the embeddings (e.g., image embedding 514, object label embedding 518, bounding box embedding 522) with a multimodal encoder 526. The multimodal encoder 526 may process the embeddings (e.g., image embedding 514, object label embedding 518, bounding box embedding 522) to generate a multimodal representation 528 associated with the input data 502.

The multimodal ROI model 500 may then process the multimodal representation 528 to determine a descriptive relationship between the object label 506 and the bounding box 510. More particularly, the multimodal ROI model 500 may process the multimodal representation 528 with a binary classification head 530, which determines whether the bounding box 510 includes the particular object 508 referred to by the object label 506. For instance, the binary classification head 530 may include and/or may otherwise output data 532 indicative of the descriptive relationship between the object label 506 and the bounding box 510. The multimodal ROI model 500 may then generate a likelihood score 534 based on the descriptive relationship (e.g., output data 532) determined by the binary classification head 530.

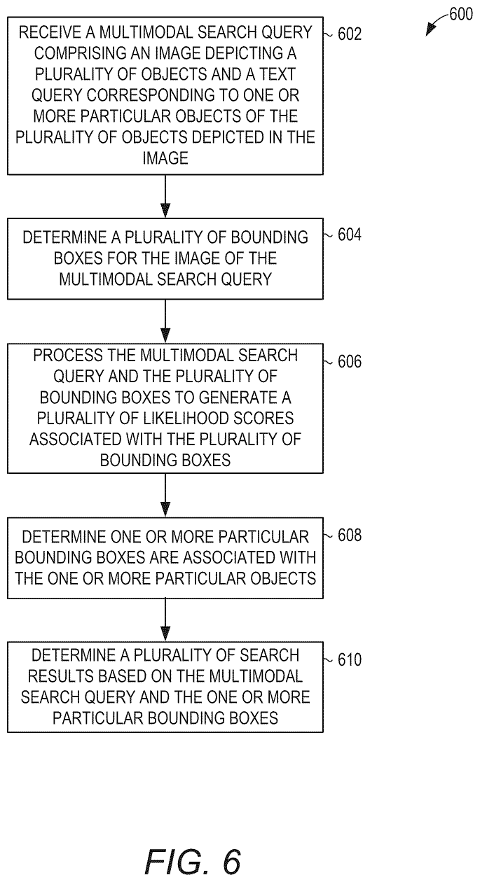

FIG. 6 depicts a flow chart diagram of an example method 600 for implementing a multimodal query-based search according to example embodiments of the present disclosure. FIG. 6 depicts steps performed in a particular order for purposes of illustration and discussion. Those having ordinary skill in the art, using the disclosures provided herein, will understand that various steps of any of the methods described herein may be omitted, expanded, performed simultaneously, rearranged, and/or modified in various ways without deviating from the scope of the present disclosure. Furthermore, various steps (not illustrated) may be performed without deviating from the scope of the present disclosure.

Referring to FIG. 6 at (602), a computing system may receive a multimodal search query. The multimodal search query may include an image and a text query. The image may depict a plurality of objects, scenes, and/or other features. The text query may be descriptive of and/or otherwise correspond to one or more particular objects, scenes, features, etc. of the plurality of objects, scenes, features, etc. depicted in the image.

At (604), an object detection model of the computing system may determine a plurality of bounding boxes for the image of the multimodal search query. Each bounding box may respectively identify at least one of the plurality of objects, scenes, features, etc. depicted in the image. More particularly, in some examples, the object detection model may receive the image of the multimodal query and may process the image to identify the plurality of objects depicted in the image. In such examples, the object detection model may generate at least one bounding box identifying each object of the plurality of objects depicted in the image.

At (606), a multimodal region-of-interest (ROI) model of the computing system may process the multimodal search query and the plurality of bounding boxes to generate a plurality of likelihood scores associated with the plurality of bounding boxes. Each likelihood score may be descriptive of a predicted likelihood that a respective bounding box of the plurality of bounding boxes is associated with the text query.

In some examples, the multimodal ROI model may include a multitask unified model (MUM) (e.g., the multitask unified model of Nayak, Pandu “MUM: A new AI milestone for understanding information”, GOOGLE: THE KEYWORD (May 18, 2021), https://blog.google/products/search/introducing-mum/. & “MUM: how new Google's algorithm will change NLP”, MEDIUM (May 16, 2022), https://medium.com/geekculture/mum-how-new-googles-algorithm-will-change-nlp-3daebf47b85d). In some examples, the multimodal ROI model may be trained to determine whether the one or more particular bounding boxes are associated with the one or more particular objects based on training data generated by a generative language model, such as, by way of non-limiting example, a pre-trained vision language model.

More particularly, the multimodal ROI model may process the multimodal search query to generate one or more multimodal embeddings. The multimodal ROI model may process each bounding box of the plurality of bounding boxes to generate one or more corresponding bounding box embeddings. The multimodal ROI model may process the one or more multimodal embeddings and each of the one or more corresponding bounding box embeddings (e.g., for each bounding box of the plurality of bounding boxes) to determine a descriptive relationship between the text query of the multimodal search query and the corresponding bounding box. The multimodal ROI model may then generate a likelihood score for each bounding box based on the descriptive relationship between the corresponding bounding box and the text query of the multimodal query.

At (608), the computing system may determine one or more particular bounding boxes are associated with the one or more particular objects. More particularly, in some examples, the multimodal ROI model of the computing system may process the plurality of likelihood scores associated with the plurality of bounding boxes to generate a ranked bounding box list. The ranked bounding box list may include the plurality of bounding boxes ordered (e.g., sorted) based on the plurality of likelihood scores. The computing system may determine one or more particular bounding boxes of the plurality of bounding boxes of the ranked bounding box list are associated with the one or more particular objects based on the plurality of likelihood scores.

At (610), a search engine of the computing system may determine a plurality of search results based on the multimodal search query and the one or more particular bounding boxes.

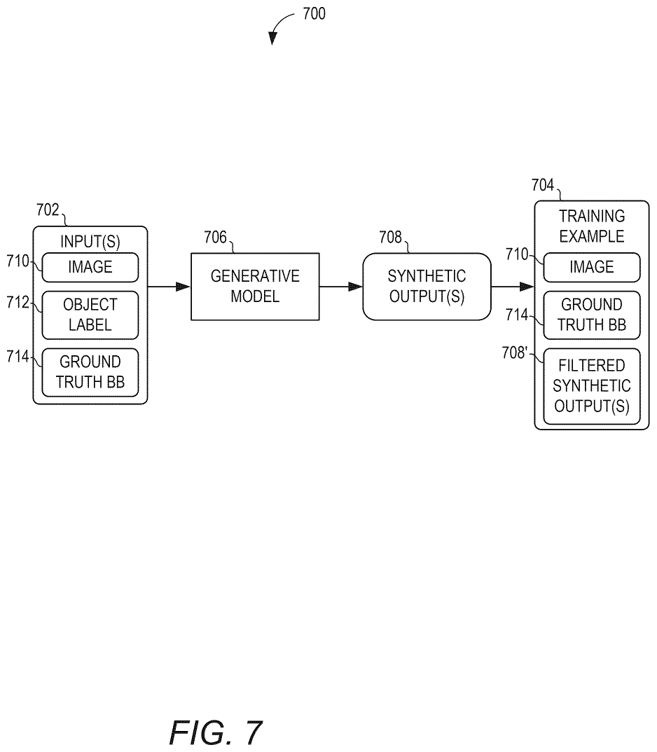

FIG. 7 depicts a block diagram of an example training example generation system 700 according to example embodiments of the present disclosure. Each component of the training example generation system 700 may be implemented using hardware, software, and/or a combination thereof. In some examples, the training example generation system 700 is configured to receive, and/or obtain, a set of input data 702 descriptive of a particular object depicted in an image and, as a result of receipt of the input data 702, generate, determine, and/or provide a training example 704 that includes training data for a multimodal region-of-interest (ROI) model, such as the multimodal ROI model 108 (FIG. 1), the multimodal ROI model 212 (FIG. 2), the multimodal ROI model 500 (FIG. 5), and/or the like. Thus, in some examples, the training example generation system 700 may include a generative model 706 that is operable to process the input data 702 and generate one or more synthetic outputs 708 based on one or more attributes associated with the input data 702.

More particularly, the training example generation system 700 may receive and/or may otherwise obtain the input data 702. The input data 702 may include an image 710, an object label 712, and a ground truth bounding box 714. The image 710 may depict a plurality of objects, and the object label 712 may be associated with a particular object of the plurality of objects depicted in the image 710. That is, the object label 712 may include a direct reference expression with one or more terms that directly reference the particular object depicted in the image 710. The ground truth bounding box 714 may be associated with a position of the particular object within the image 710. That is, the ground truth bounding box 714 may be and/or may otherwise include a bounding box associated with the position of the particular object within the image 710.

The training example generation system 700 may process the input data 702 (e.g., image 710, object label 712, ground truth bounding box 714) with the generative model 706. In some examples, the generative model 706 may be a generative language model. Additionally and/or alternatively, in some examples, the generative model 706 may be a pre-trained vision model. Additionally and/or alternatively, in some examples, the generative model 706 may be a chain-of-thought language model that is trained using chain-of-thought prompting.

More particularly, the generative model 706 may process the input data 702 (e.g., image 710, object label 712, ground truth bounding box 714) to generate the one or more synthetic outputs 708. In some examples, the one or more synthetic outputs 708 may be synthetic reference expressions that reference the particular object depicted in the image 710 without using a term from the object label 712. For instance, in some examples, the generative model 706 may be prompted to generate one or more synthetic outputs 708 (e.g., synthetic reference expressions) based on one or more attributes of the ground truth bounding box 714. In such examples, the generative model 706 may generate the one or more synthetic outputs 708 (e.g., synthetic reference expressions) such that each synthetic output 708 describes the particular object depicted in the image 710 with one or more terms that are different relative to the one or more terms from the object label 712.

The training example generation system 700 may then process the image 710 and the one or more synthetic outputs 708 to generate the training example 704. The training example 704 may include the image 710, the ground truth bounding box 714, and at least one of the synthetic outputs 708 (e.g., filtered synthetic output 708′). More particularly, the training example generation system 700 may process the image 710 and the one or more synthetic outputs 708 to generate one or more likelihood scores associated with the one or more synthetic outputs 708. Each likelihood score may be descriptive of a predicted likelihood that a respective synthetic output 708 is associated with one or more additional objects of the plurality of objects depicted in the image 710 that are different relative to the particular object. Based on the one or more likelihood scores, the training example generation system 700 may determine that one or more particular synthetic outputs 708 are associated with the one or more additional objects depicted in the image 710. In such instances, the training example generation system 700 may process the one or more synthetic outputs 708 to generate one or more filtered synthetic outputs 708′, which correspond to the synthetic outputs 708 that are different from the one or more particular synthetic outputs 708 that are associated with the one or more additional objects depicted in the image 710. The training example generation system 700 may then generate the training example 704, which may include the image 710, the ground truth bounding box 714, and the one or more filtered synthetic outputs 708′.

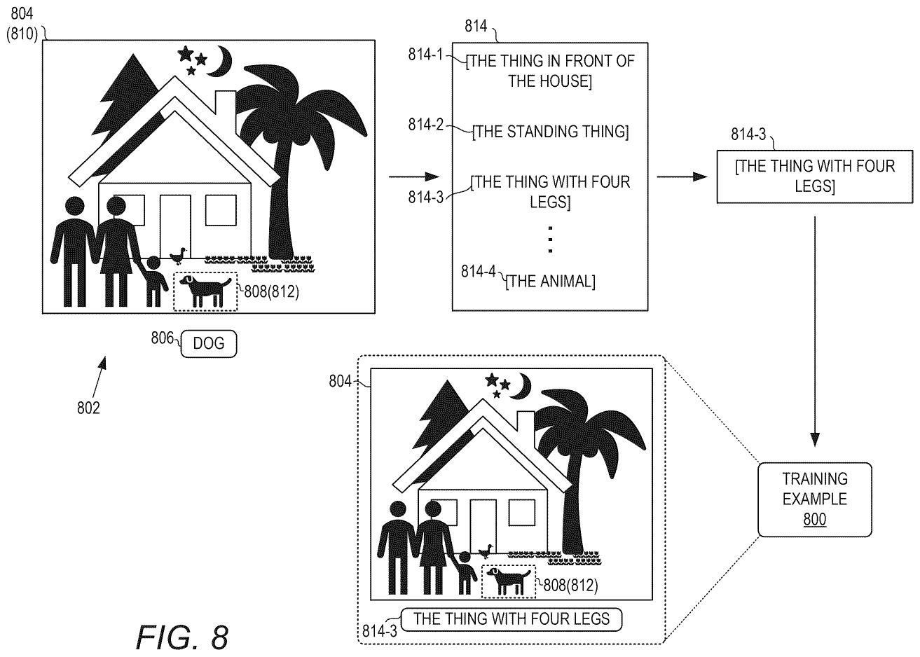

FIG. 8 depicts an illustrative sequence of generating a training example 800 according to example embodiments of the present disclosure. The training example 800 may be generated by a computing system, such as the training example generation system 700 (FIG. 7). The training example 800 may be utilized to train a multimodal region-of-interest (ROI) model, such as the multimodal ROI model 108 (FIG. 1), the multimodal ROI model 212 (FIG. 2), the multimodal ROI model 500 (FIG. 5), and/or the like.

As shown, input data 802 may include an image 804, an object label 806, and a ground truth bounding box 808. The image 804 may depict a plurality of objects 810. More particularly, in the illustrative non-limiting example of FIG. 8, the plurality of objects 810 include humans (e.g., adults, child), animals (e.g., dog, duck), a house, trees, flowers, stars, etc. The object label 806 includes a reference expression (e.g., “DOG”) that directly references a particular object 812 (e.g., dog). The ground truth bounding box 808 corresponds to a position of the particular object 812 (e.g., dog) within the image 804.

The input data 802 may be processed by a generative model, which is prompted to generate a plurality of synthetic reference expressions 814 that include different terms relative to the object label 806 (e.g., “DOG”). The plurality of synthetic reference expressions 814 may be processed to generate a filtered synthetic reference expression 814′, which corresponds to a synthetic reference expression 814 that is not associated with any object 810 depicted in the image 804 except for the particular object 812 (e.g., dog).

For instance, a first synthetic reference expression 814-1 (e.g., “THE THING IN FRONT OF THE HOUSE”) may correspond to more than one object 810 depicted in the image 804 (e.g., humans, animals, flowers). A second synthetic reference expression 814-2 (e.g., “THE STANDING THING”) may also correspond to more than one object 810 depicted in the image 804 (e.g., humans, animals). A fourth synthetic reference expression 814-4 (e.g., “THE ANIMAL”) may also correspond to more than one object 810 depicted in the image 804 (e.g., dog, duck). However, a third synthetic reference expression 814-3 (e.g., “THE THING WITH FOUR LEGS”) may only correspond to the particular object 812 (e.g., dog).

As such, a training example generation system may generate the training example 800 such that the training example 800 includes the image 804, the ground truth bounding box 808, and the filtered synthetic reference expression 814′ (e.g., third synthetic reference expression 814-3). Subsequently, the training example 800 may be utilized to train a multimodal ROI model to determine one or more particular bounding boxes associated with a particular object depicted in an image of a multimodal input.

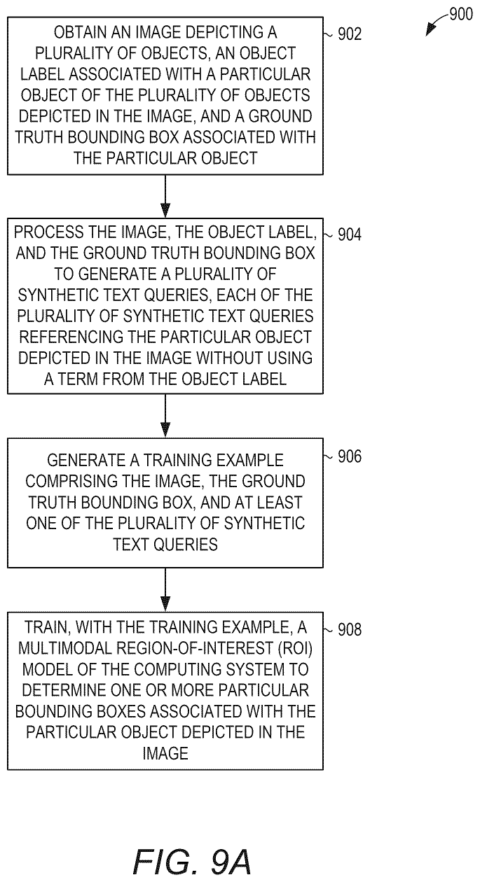

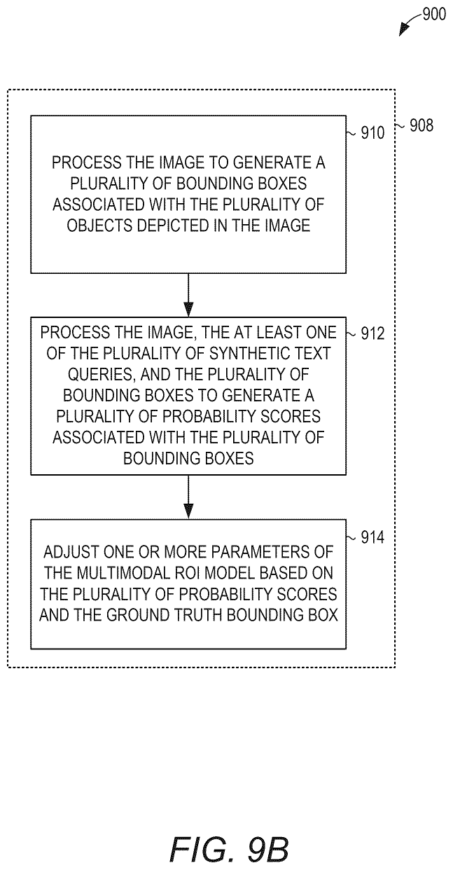

FIG. 9A-9B depict flow chart diagrams of an example method 900 for training a multimodal region-of-interest (ROI) model according to example embodiments of the present disclosure. FIG. 9A-9B depict steps performed in a particular order for purposes of illustration and discussion. Those having ordinary skill in the art, using the disclosures provided herein, will understand that various steps of any of the methods described herein may be omitted, expanded, performed simultaneously, rearranged, and/or modified in various ways without deviating from the scope of the present disclosure. Furthermore, various steps (not illustrated) may be performed without deviating from the scope of the present disclosure.

Referring to FIG. 9A at (902), the computing system may obtain an image, an object label, and a ground truth bounding box. The image may depict a plurality of objects. The object label may be associated with a particular object of the plurality of objects depicted in the image. The ground truth bounding box may be associated with a position of the particular object within the image.

At (904), the computing system may process the image, the object label, and the ground truth bounding box with a generative language model to generate a plurality of synthetic text queries. Each synthetic text query may refer to the particular object in the image without using a term from the object label. More particularly, in some examples, the generative language model may be prompted to generate one or more synthetic reference expressions based on one or more attributes of the ground truth bounding box. In such examples, the one or more synthetic reference expressions may include one or more terms that are different relative to the term from the object label. In some examples, the generative language model may be a chain-of-thought language model and may be trained using chain-of-thought prompting. Additionally and/or alternatively, in some examples, the generative language model may be a pre-trained vision language model.

At (906), the computing system may generate a training example. The training example may include the image, the ground truth bounding box, and at least one of the plurality of synthetic text queries. More particularly, the computing system may process the image and the plurality of synthetic text queries to generate a plurality of likelihood scores associated with the plurality of synthetic text queries. Each of the plurality of likelihood scores may be descriptive of a predicted likelihood that a respective synthetic text query is associated with one or more additional objects of the plurality of objects depicted in the image. That is, each likelihood score may be descriptive of the predicted likelihood that a respective text query is associated with one or more different objects relative to the particular object.

The computing system may generate the training example based on the plurality of likelihood scores. More particularly, the computing system may determine that one or more particular synthetic text queries of the plurality of synthetic text queries are associated with the one or more additional objects depicted in the image based on the plurality of likelihood scores. The computing system may process the plurality of synthetic text queries to generate one or more filtered synthetic text queries. The one or more filtered synthetic text queries may correspond to one or more of the plurality of synthetic text queries that are different from the one or more particular synthetic text queries. The computing system may generate the training example, which may include the image, the ground truth bounding box, and at least one of the one or more filtered synthetic text queries.

At (908), the computing system may train a multimodal region-of-interest (ROI) model with the training example. The multimodal ROI model may be trained to determine one or more particular bounding boxes associated with the particular object depicted in the image. In some examples, the multimodal ROI model may be a multitask unified model (MUM).

More particularly, referring now to FIG. 9B at (910), the computing system may process the image to generate a plurality of bounding boxes associated with the plurality of objects depicted in the image.

At (912), the computing system may process the image, the at least one of the plurality of synthetic text queries, and the plurality of bounding boxes to generate a plurality of probability scores associated with the plurality of bounding boxes.

At (914), the computing system may adjust one or more parameters of the multimodal ROI model based on the plurality of probability scores and the ground truth bounding box. More particularly, in some examples, the computing system may evaluate a loss function based on a difference between one or more of the plurality of probability scores and the ground truth bounding box. In such examples, the computing system may adjust the one or more parameters of the multimodal ROI model based on the loss function. In some examples, the loss function may include a penalization term. The penalization term may be based on differences between the position of the particular object depicted in the image and respective positions of the plurality of objects associated with the plurality of bounding boxes.

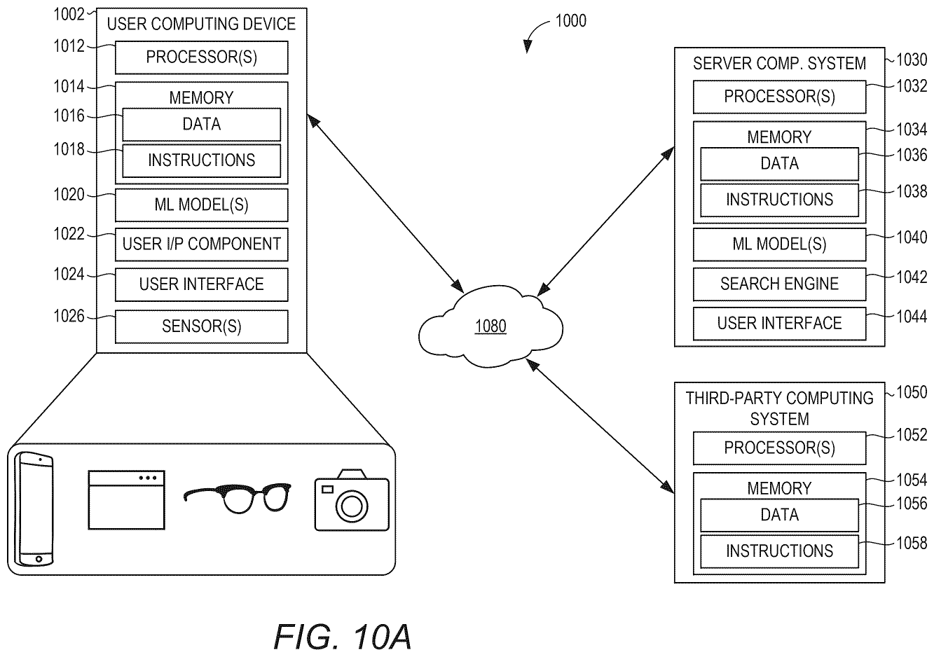

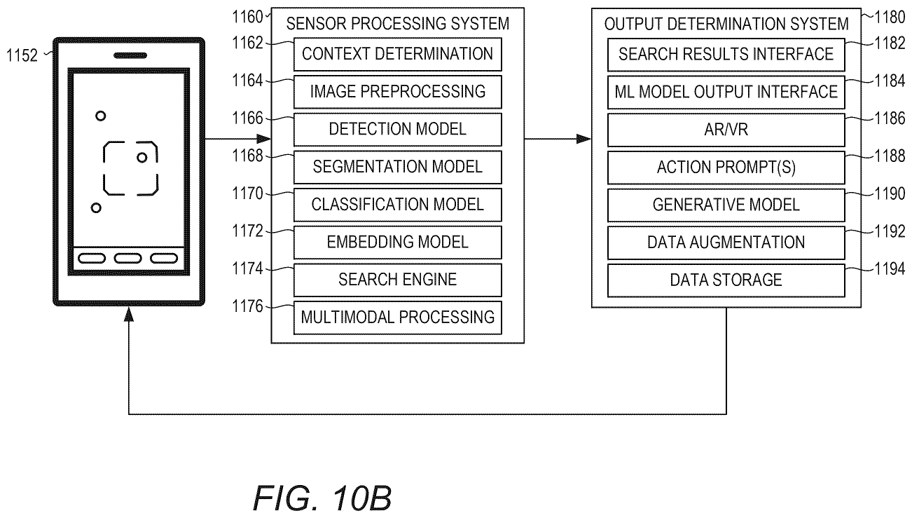

FIG. 10A depicts a block diagram of an example computing system 1000 according to example embodiments of the present disclosure. The system 1000 includes a user computing system 1002, a server computing system 1030, and/or a third party computing system 1050 that are communicatively coupled over a network 1080.

The user computing system 1002 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 1002 includes one or more processors 1012 and a memory 1014. The one or more processors 1012 can be any suitable processing device (e.g., a processor core, a microprocessor, an ASIC, a FPGA, a controller, a microcontroller, etc.) and can be one processor or a plurality of processors that are operatively connected. The memory 1014 can include one or more non-transitory computer-readable storage mediums, such as RAM, ROM, EEPROM, EPROM, flash memory devices, magnetic disks, etc., and combinations thereof. The memory 1014 can store data 1016 and instructions 1018 which are executed by the processor 1012 to cause the user computing system 1002 to perform operations.

In some implementations, the user computing system 1002 can store or include one or more machine-learned models 1020. For example, the machine-learned models 1020 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 1020 can be received from the server computing system 1030 over network 1080, stored in the user computing device memory 1014, and then used or otherwise implemented by the one or more processors 1012. In some implementations, the user computing system 1002 can implement multiple parallel instances of a single machine-learned model 1020 (e.g., to perform parallel machine-learned model processing across multiple instances of input data and/or detected features).

More particularly, the one or more machine-learned models 1020 may include one or more detection models, one or more classification models, one or more segmentation models, one or more augmentation models, one or more generative models, one or more natural language processing models, one or more optical character recognition models, and/or one or more other machine-learned models. The one or more machine-learned models 1020 can include one or more transformer models. The one or more machine-learned models 1020 may include one or more neural radiance field models, one or more diffusion models, and/or one or more autoregressive language models.

The one or more machine-learned models 1020 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 1020 can process image data, text data, audio data, and/or latent encoding data to generate output data that can include image data, text data, audio data, and/or latent encoding data. The one or more machine-learned models 1020 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Machine-learned model(s) can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) can include a single or multiple instances of the same model configured to operate on data from input(s). Machine-learned model(s) can include an ensemble of different models that can cooperatively interact to process data from input(s). For example, machine-learned model(s) can employ a mixture-of-experts structure. See, e.g., Zhou et al., Mixture-of-Experts with Expert Choice Routing, ARXIV:2202.09368v2 (Oct. 14, 2022).

Input(s) can generally include or otherwise represent various types of data. Input(s) can include one type or many different types of data. Output(s) can be data of the same type(s) or of different types of data as compared to input(s). Output(s) can include one type or many different types of data.

Example data types for input(s) or output(s) include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs or outputs, example combinations of data types include image data and audio data, image data and natural language data, natural language data and software code data, image data and biometric data, sensor data and medical data, etc. It is to be understood that any combination of data types in an input or an output can be present.

An example input can include one or multiple data types, such as the example data types noted above. An example output can include one or multiple data types, such as the example data types noted above. The data type(s) of input can be the same as or different from the data type(s) of output. It is to be understood that the example data types noted above are provided for illustrative purposes only. Data types contemplated within the scope of the present disclosure are not limited to those examples noted above.

Additionally or alternatively, one or more machine-learned models 1040 can be included in or otherwise stored and implemented by the server computing system 1030 that communicates with the user computing system 1002 according to a client-server relationship. For example, the machine-learned models 1040 can be implemented by the server computing system 1030 as a portion of a web service (e.g., a viewfinder service, a visual search service, an image processing service, an ambient computing service, and/or an overlay application service). Thus, one or more models 1020 can be stored and implemented at the user computing system 1002 and/or one or more models 1040 can be stored and implemented at the server computing system 1030.

The user computing system 1002 can also include one or more user input components 1022 that receives user input. For example, the user input component 1022 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system 1002 can store and/or provide one or more user interfaces 1024, which may be associated with one or more applications. The one or more user interfaces 1024 can be configured to receive inputs and/or provide data for display (e.g., image data, text data, audio data, one or more user interface elements, an augmented-reality experience, a virtual reality experience, and/or other data for display. The user interfaces 1024 may be associated with one or more other computing systems (e.g., server computing system 1030 and/or third party computing system 1050). The user interfaces 1024 can include a viewfinder interface, a search interface, a generative model interface, a social media interface, and/or a media content gallery interface.

The user computing system 1002 may include and/or receive data from one or more sensors 1026. The one or more sensors 1026 may be housed in a housing component that houses the one or more processors 1012, the memory 1014, and/or one or more hardware components, which may store, and/or cause to perform, one or more software packets. The one or more sensors 1026 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 1002 may include, and/or be part of, a user computing device 1004. The user computing device 1004 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more user computing devices 1004. For example, a camera of a smartphone may be utilized to capture image data descriptive of the environment, and/or an overlay application of the user computing device 1004 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 1030 includes one or more processors 1032 and a memory 1034. The one or more processors 1032 can be any suitable processing device (e.g., a processor core, a microprocessor, an ASIC, a FPGA, a controller, a microcontroller, etc.) and can be one processor or a plurality of processors that are operatively connected. The memory 1034 can include one or more non-transitory computer-readable storage mediums, such as RAM, ROM, EEPROM, EPROM, flash memory devices, magnetic disks, etc., and combinations thereof. The memory 1034 can store data 1036 and instructions 1038 which are executed by the processor 1032 to cause the server computing system 1030 to perform operations.

In some implementations, the server computing system 1030 includes or is otherwise implemented by one or more server computing devices. In instances in which the server computing system 1030 includes plural server computing devices, such server computing devices can operate according to sequential computing architectures, parallel computing architectures, or some combination thereof.

As described above, the server computing system 1030 can store or otherwise include one or more machine-learned models 1040. For example, the models 1040 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 1040 are discussed with reference to FIG. 10B.

Additionally and/or alternatively, the server computing system 1030 can include and/or be communicatively connected with a search engine 1042 that may be utilized to crawl one or more databases (and/or resources). The search engine 1042 can process data from the user computing system 1002, the server computing system 1030, and/or the third party computing system 1050 to determine one or more search results associated with the input data. The search engine 1042 may perform term based search, label based search, Boolean based searches, image search, embedding based search (e.g., nearest neighbor search), multimodal search, and/or one or more other search techniques.

The server computing system 1030 may store and/or provide one or more user interfaces 1044 for obtaining input data and/or providing output data to one or more users. The one or more user interfaces 1044 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 1002 and/or the server computing system 1030 can train the models 1020 and/or 1040 via interaction with the third party computing system 1050 that is communicatively coupled over the network 1080. The third party computing system 1050 can be separate from the server computing system 1030 or can be a portion of the server computing system 1030. Alternatively and/or additionally, the third party computing system 1050 may be associated with one or more web resources, one or more web platforms, one or more other users, and/or one or more contexts.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model's performance on that runtime instance (e.g., online training/learning). Example data types for the training instance and various tasks associated therewith are described throughout the present disclosure.

The third party computing system 1050 can include one or more processors 1052 and a memory 1054. The one or more processors 1052 can be any suitable processing device (e.g., a processor core, a microprocessor, an ASIC, a FPGA, a controller, a microcontroller, etc.) and can be one processor or a plurality of processors that are operatively connected. The memory 1054 can include one or more non-transitory computer-readable storage mediums, such as RAM, ROM, EEPROM, EPROM, flash memory devices, magnetic disks, etc., and combinations thereof. The memory 1054 can store data 1056 and instructions 1058 which are executed by the processor 1052 to cause the third party computing system 1050 to perform operations. In some implementations, the third party computing system 1050 includes or is otherwise implemented by one or more server computing devices.

The network 1080 can be any type of communications network, such as a local area network (e.g., intranet), wide area network (e.g., Internet), or some combination thereof and can include any number of wired or wireless links. In general, communication over the network 1080 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, the task can be a generative task, and the one or more machine-learned models (e.g., 1020 and/or 1040) can be configured to output content generated in view of one or more inputs. For instance, the inputs can be or otherwise represent data of one or more modalities that encodes context for generating additional content.

In some implementations, the task can be a text completion task. The machine-learned models can be configured to process the inputs that represent textual data and to generate the outputs that represent additional textual data that completes a textual sequence that includes the inputs. For instance, the machine-learned models can be configured to generate the outputs to complete a sentence, paragraph, or portion of text that follows from a portion of text represented by inputs.

In some implementations, the task can be an instruction following task. The machine-learned models can be configured to process the inputs that represent instructions to perform a function and to generate the outputs that advance a goal of satisfying the instruction function (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the instructions (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the instructions (e.g., natural language responses, programming language responses, machine language responses, etc.). One or more outputs can be iteratively or recursively generated to sequentially process and accomplish steps toward accomplishing the requested functionality. For instance, an initial output can be executed by an external system or be processed by the machine-learned models to complete an initial step of performing a function. Multiple steps can be performed, with a final output being obtained that is responsive to the initial instructions.

In some implementations, the task can be a question answering task. The machine-learned models can be configured to process the inputs that represent a question to answer and to generate the outputs that advance a goal of returning an answer to the question (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the question (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the question (e.g., natural language responses, programming language responses, machine language responses, etc.). One or more outputs can be iteratively or recursively generated to sequentially process and accomplish steps toward answering the question. For instance, an initial output can be executed by an external system or be processed by the machine-learned models to complete an initial step of obtaining an answer to the question (e.g., querying a database, performing a computation, executing a script, etc.). Multiple steps can be performed, with a final output being obtained that is responsive to the question.

In some implementations, the task can be an image generation task. The machine-learned models can be configured to process the inputs that represent context regarding a desired portion of image content. The context can include text data, image data, audio data, etc. Machine-learned models can be configured to generate the outputs that represent image data that depicts imagery related to the context. For instance, the machine-learned models can be configured to generate pixel data of an image. Values for channels associated with the pixels in the pixel data can be selected based on the context (e.g., based on a probability determined based on the context).

In some implementations, the task can be a data generation task. Machine-learned models can be configured to process the inputs that represent context regarding a desired portion of data (e.g., data from various data domains, such as sensor data, image data, multimodal data, statistical data, etc.). The desired data can be, for instance, synthetic data for training other machine-learned models. The context can include arbitrary data types. The machine-learned models can be configured to generate the outputs that represent data that aligns with the desired data. For instance, the machine-learned models can be configured to generate data values for populating a dataset. Values for the data objects can be selected based on the context (e.g., based on a probability determined based on the context).

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 1002 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing system 1000.

The central intelligence layer can communicate with a central device data layer. The central device data layer can be a centralized repository of data for the computing system 1000. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 10B depicts a block diagram of an example computing system 1150 according to example embodiments of the present disclosure. In particular, the example computing system 1150 can include one or more computing devices 1152 that can be utilized to obtain, and/or generate, one or more datasets that can be processed by a sensor processing system 1160 and/or an output determination system 1180 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 1152 (e.g., one or more sensors in the computing device 1152). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 1152 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 1160. The sensor processing system 1160 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 1162, which may determine a context associated with one or more content items. The context determination block 1162 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 1160 may include an image preprocessing block 1164. The image preprocessing block 1164 may be utilized to adjust one or more values of an obtained and/or received image to prepare the image to be processed by one or more machine-learned models and/or one or more search engines 1174. The image preprocessing block 1164 may resize the image, adjust saturation values, adjust resolution, strip and/or add metadata, and/or perform one or more other operations.

In some implementations, the sensor processing system 1160 can include one or more machine-learned models, which may include a detection model 1166, a segmentation model 1168, a classification model 1170, an embedding model 1172, and/or one or more other machine-learned models. For example, the sensor processing system 1160 may include one or more detection models 1166 that can be utilized to detect particular features in the processed dataset. In particular, one or more images can be processed with the one or more detection models 1166 to generate one or more bounding boxes associated with detected features in the one or more images.

Additionally and/or alternatively, one or more segmentation models 1168 can be utilized to segment one or more portions of the dataset from the one or more datasets. For example, the one or more segmentation models 1168 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 1170 can be utilized to process image data, text data, audio data, latent encoding data, multimodal data, and/or other data to generate one or more classifications. The one or more classification models 1170 can include one or more image classification models, one or more object classification models, one or more text classification models, one or more audio classification models, and/or one or more other classification models. The one or more classification models 1170 can process data to determine one or more classifications.

In some implementations, data may be processed with one or more embedding models 1172 to generate one or more embeddings. For example, one or more images can be processed with the one or more embedding models 1172 to generate one or more image embeddings in an embedding space. The one or more image embeddings may be associated with one or more image features of the one or more images. In some implementations, the one or more embedding models 1172 may be configured to process multimodal data to generate multimodal embeddings. The one or more embeddings can be utilized for classification, search, and/or learning embedding space distributions.

The sensor processing system 1160 may include one or more search engines 1174 that can be utilized to perform one or more searches. The one or more search engines 1174 may crawl one or more databases (e.g., one or more local databases, one or more global databases, one or more private databases, one or more public databases, one or more specialized databases, and/or one or more general databases) to determine one or more search results. The one or more search engines 1174 may perform feature matching, text based search, embedding based search (e.g., k-nearest neighbor search), metadata based search, multimodal search, web resource search, image search, text search, and/or application search.

Additionally and/or alternatively, the sensor processing system 1160 may include one or more multimodal processing blocks 1176, which can be utilized to aid in the processing of multimodal data. The one or more multimodal processing blocks 1176 may include generating a multimodal query and/or a multimodal embedding to be processed by one or more machine-learned models and/or one or more search engines 1174.

The output(s) of the sensor processing system 1160 can then be processed with an output determination system 1180 to determine one or more outputs to provide to a user. The output determination system 1180 may include heuristic based determinations, machine-learned model based determinations, user selection based determinations, and/or context based determinations.

The output determination system 1180 may determine how and/or where to provide the one or more search results in a search results interface 1182. Additionally and/or alternatively, the output determination system 1180 may determine how and/or where to provide the one or more machine-learned model outputs in a machine-learned model output interface 1184. In some implementations, the one or more search results and/or the one or more machine-learned model outputs may be provided for display via one or more user interface elements. The one or more user interface elements may be overlayed over displayed data. For example, one or more detection indicators may be overlayed over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 1160 may be utilized to generate and/or provide an augmented-reality experience and/or a virtual-reality experience 1186. For example, the one or more obtained datasets may be processed to generate one or more augmented-reality rendering assets and/or one or more virtual-reality rendering assets, which can then be utilized to provide an augmented-reality experience and/or a virtual-reality experience 1186 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 1188 may be determined based on the output(s) of the sensor processing system 1160. For example, a search prompt, a purchase prompt, a generate prompt, a reservation prompt, a call prompt, a redirect prompt, and/or one or more other prompts may be determined to be associated with the output(s) of the sensor processing system 1160. The one or more action prompts 1188 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 1160 may be processed with one or more generative models 1190 to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models 1190 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 1190 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 1190 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 1190 can be trained to process input data and generate model-generated content items, which may include a plurality of predicted words, pixels, signals, and/or other data. The model-generated content items may include novel content items that are not the same as any pre-existing work. The one or more generative models 90 can leverage learned representations, sequences, and/or probability distributions to generate the content items, which may include phrases, storylines, settings, objects, characters, beats, lyrics, and/or other aspects that are not included in pre-existing content items.

The one or more generative models 1190 may include a vision language model.

The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g., for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The one or more generative models 1190 may be stored on-device and/or may be stored on a server computing system. In some implementations, the one or more generative models 1190 can perform on-device processing to determine suggested searches, suggested actions, and/or suggested prompts. The one or more generative models 1190 may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models 1190 can include machine-learned sequence processing models. An example system can pass inputs to sequence processing models. Sequence processing models can include one or more machine-learned components. Sequence processing models can process the data from inputs to obtain an input sequence. Input sequence can include one or more input elements obtained from inputs. The sequence processing model can process the input sequence using prediction layers to generate an output sequence. The output sequence can include one or more output elements generated based on input sequence. The system can generate outputs based on output sequence.

The output determination system 1180 may process the one or more datasets and/or the output(s) of the sensor processing system 1160 with a data augmentation block 1192 to generate augmented data. For example, one or more images can be processed with the data augmentation block 1192 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 1160 may be stored based on a data storage block 1194 determination.

The output(s) of the output determination system 1180 can then be provided to a user via one or more output components of the user computing device 1152. For example, one or more user interface elements associated with the one or more outputs can be provided for display via a visual display of the user computing device 1152.

The processes may be performed iteratively and/or continuously. One or more user inputs to the provided user interface elements may condition and/or affect successive processing loops.

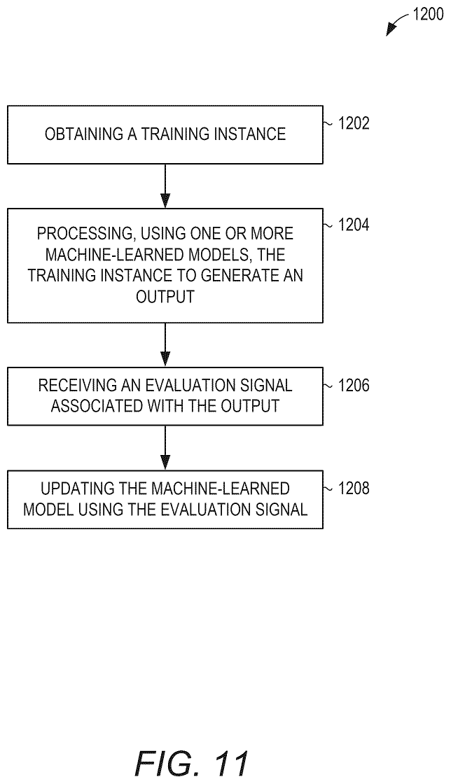

FIG. 11 depicts a flowchart of a method 1200 for training one or more machine-learned models according to aspects of the present disclosure. For instance, an example machine-learned model can include a multimodal region-of-interest (ROI) model, a generative language model, and/or the like.

One or more portion(s) of example method 1200 can be implemented by a computing system that includes one or more computing devices such as, for example, computing systems described with reference to the other figures. Each respective portion of example method 1200 can be performed by any (or any combination) of one or more computing devices. Moreover, one or more portion(s) of example method 1200 can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of example method 1200 can be performed additionally, or alternatively, by other systems.

At 1202, example method 1200 can include obtaining a training instance. A set of training data can include a plurality of training instances divided between multiple datasets (e.g., a training dataset, a validation dataset, or testing dataset). A training instance can be labeled or unlabeled. Although referred to in example method 1200 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1204, example method 1200 can include processing, using one or more machine-learned models, the training instance to generate an output. The output can be directly obtained from the one or more machine-learned models or can be a downstream result of a chain of processing operations that includes an output of the one or more machine-learned models.

At 1206, example method 1200 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1208, example method 1200 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1200 can include implementing a number of generalization techniques (e.g., weight decays, dropouts, etc.) to improve the generalization capability of the models being trained.

In some implementations, example method 1200 can be implemented for training a machine-learned model from an initialized state to a fully trained state (e.g., when the model exhibits a desired performance profile, such as based on accuracy, precision, recall, etc.).

In some implementations, example method 1200 can be implemented for particular stages of a training procedure. For instance, in some implementations, example method 1200 can be implemented for pre-training a machine-learned model. Pre-training can include, for instance, large-scale training over potentially noisy data to achieve a broad base of performance levels across a variety of tasks/data types. In some implementations, example method 1200 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

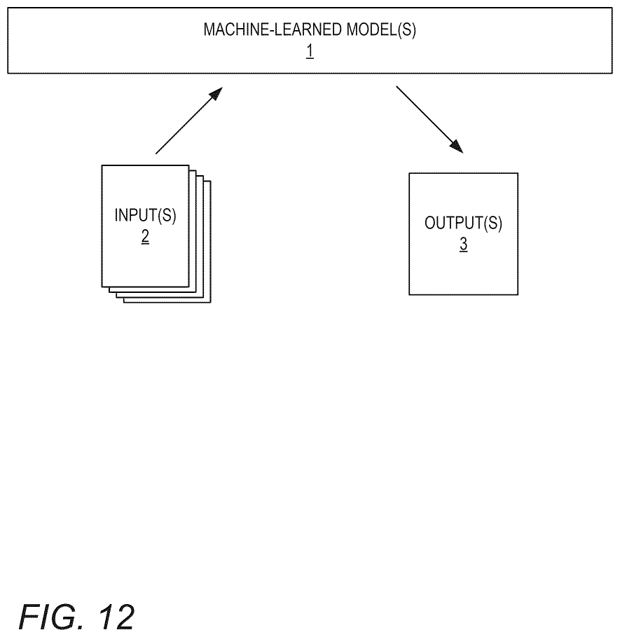

FIG. 12 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

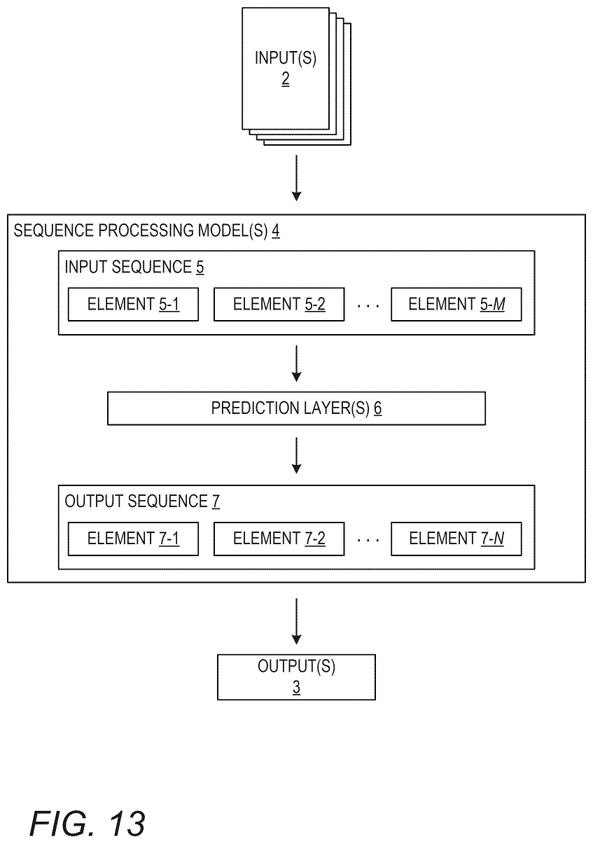

FIG. 13 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (October 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 13 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

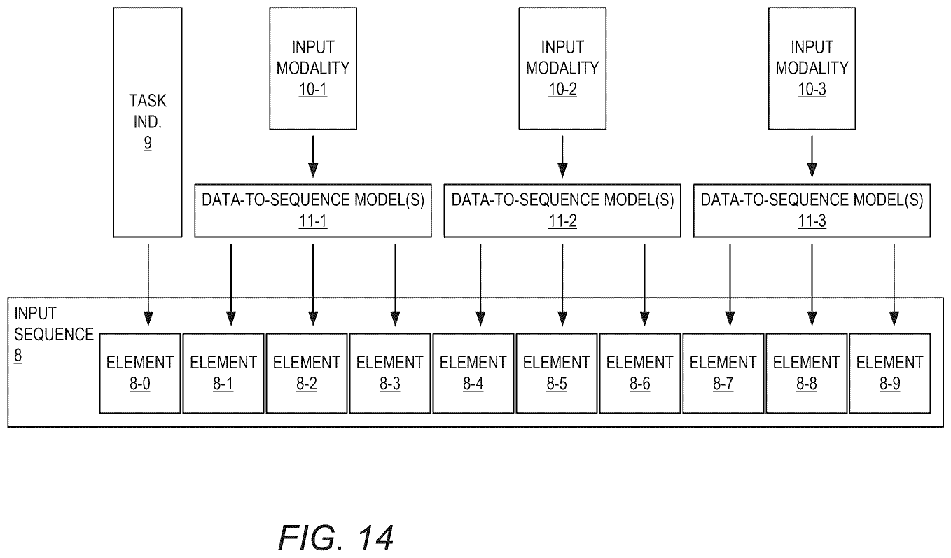

FIG. 14 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

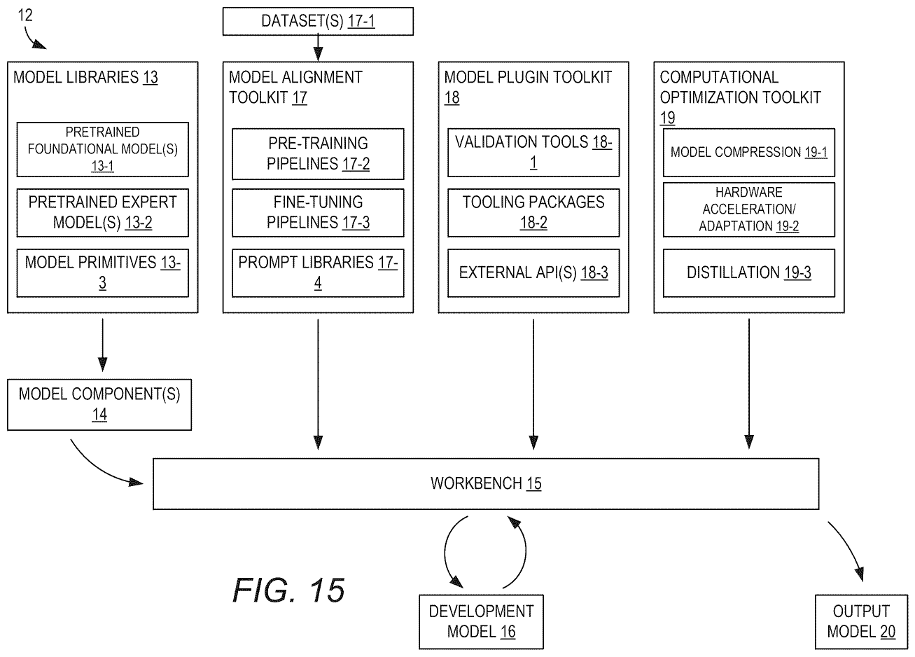

FIG. 15 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method {M}00 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

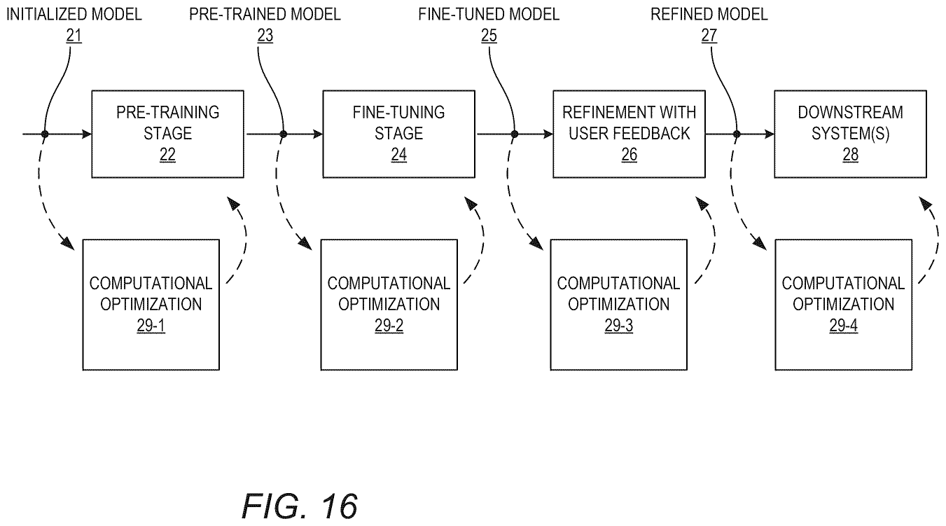

FIG. 16 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 16 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 16 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

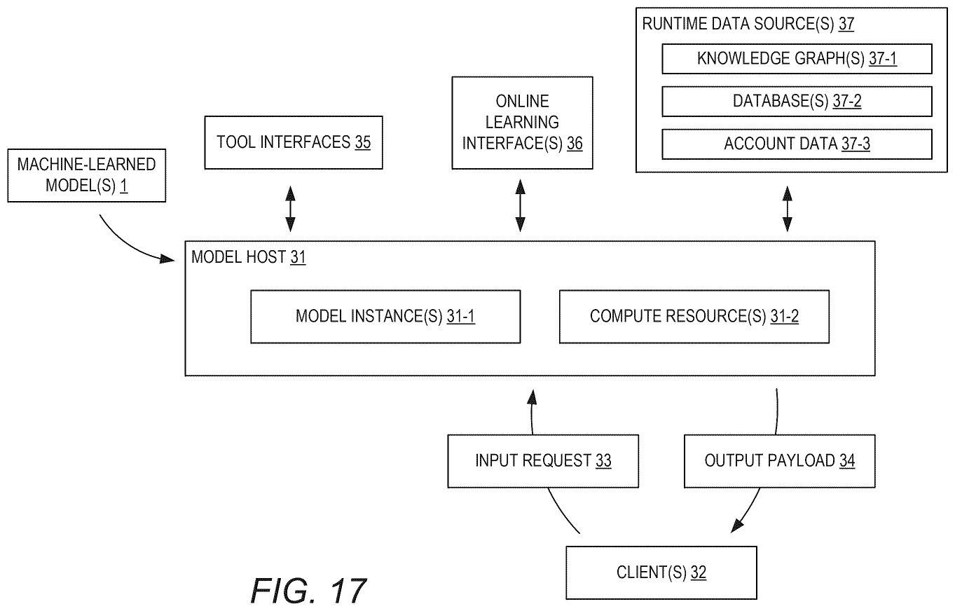

FIG. 17 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also share model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

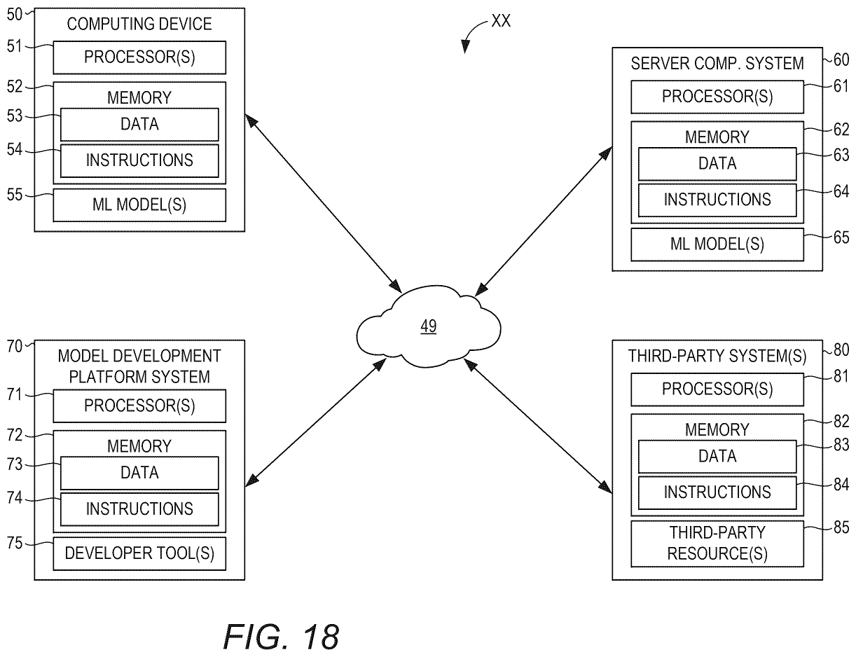

FIG. 18 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 18 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 18 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

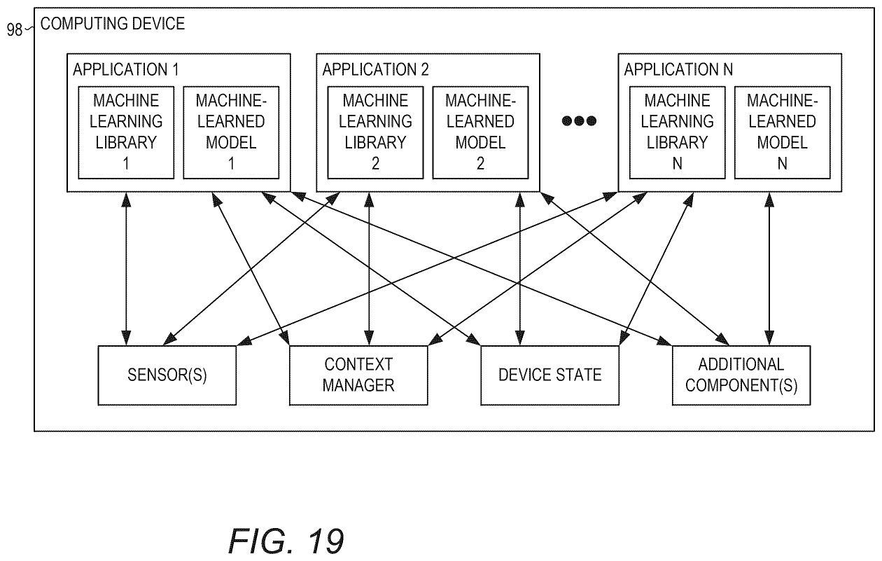

FIG. 19 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 19, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

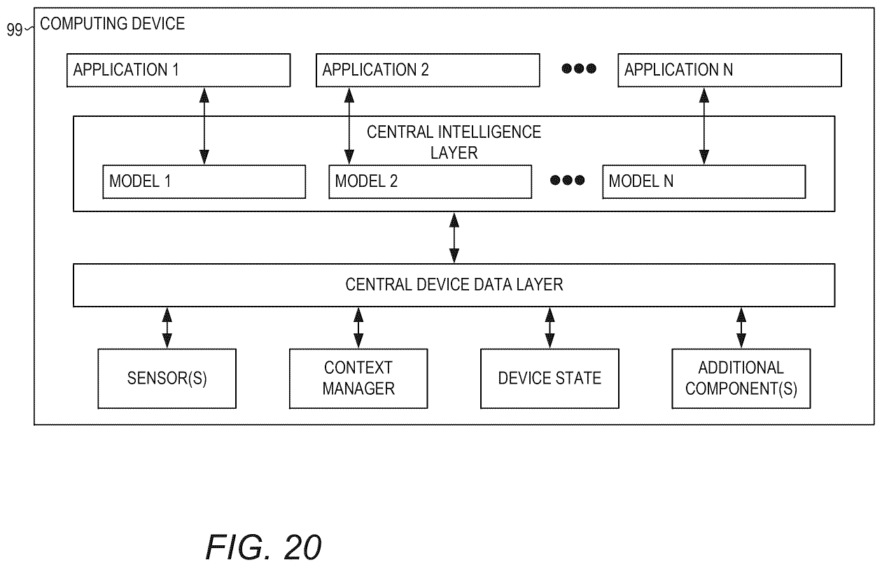

FIG. 20 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 20, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 20, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, comprising:
obtaining, by a computing system comprising one or more processors, an image depicting a plurality of objects, an object label associated with a particular object of the plurality of objects depicted in the image, and a ground truth bounding box associated with a position of the particular object within the image;
processing, by the computing system, the image, the object label, and the ground truth bounding box with a generative language model to generate a plurality of synthetic text queries, each of the plurality of synthetic text queries referencing the particular object depicted in the image without using a term from the object label;
generating, by the computing system, a training example comprising the image, the ground truth bounding box, and at least one of the plurality of synthetic text queries; and
training, by the computing system with the training example, a multimodal region-of-interest (ROI) model of the computing system to determine one or more particular bounding boxes associated with the particular object depicted in the image.

2. The computer-implemented method of claim 1, wherein training the multimodal ROI model of the computing system comprise:
processing, by the computing system, the image to generate a plurality of bounding boxes associated with the plurality of objects depicted in the image;
processing, by the computing system, the image, the at least one of the plurality of synthetic text queries, and the plurality of bounding boxes to generate a plurality of probability scores associated with the plurality of bounding boxes; and
adjusting, by the computing system, one or more parameters of the multimodal ROI model based on the plurality of probability scores and the ground truth bounding box.

3. The computer-implemented method of claim 2, wherein adjusting the one or more parameters of the multimodal ROI model comprises:
evaluating, by the computing system, a loss function based on a difference between one or more of the plurality of probability scores and the ground truth bounding box; and
adjusting, by the computing system, the one or more parameters of the multimodal ROI model based on the loss function.

4. The computer-implemented method of claim 3, wherein the loss function comprises a penalization term based on differences between the position of the particular object depicted in the image and respective positions of the plurality of objects associated with the plurality of bounding boxes.

5. The computer-implemented method of claim 1, wherein generating the training example comprises:
processing, by the computing system, the image and the plurality of synthetic text queries to generate a plurality of likelihood scores associated with the plurality of synthetic text queries, each of the plurality of likelihood scores being descriptive of a predicted likelihood that a respective synthetic text query is associated with one or more additional objects of the plurality of objects depicted in the image, the one or more additional objects being different objects relative to the particular object; and
generating, by the computing system, the training example based on the plurality of likelihood scores.

6. The computer-implemented method of claim 5, wherein generating the training example based on the plurality of likelihood scores comprises:
determining, by the computing system based on the plurality of likelihood scores, that one or more particular synthetic text queries of the plurality of synthetic text queries are associated with the one or more additional objects depicted in the image; and
processing, by the computing system, the plurality of synthetic text queries to generate one or more filtered synthetic text queries, the one or more filtered synthetic text queries corresponding to one or more of the plurality of synthetic text queries that are different from the one or more particular synthetic text queries.

7. The computer-implemented method of claim 6, wherein generating the training example based on the plurality of likelihood scores further comprises:
generating, by the computing system, the training example comprising the image, the ground truth bounding box, and at least one of the one or more filtered synthetic text queries.

8. The computer-implemented method of claim 1, wherein processing the image, the object label, and the ground truth bounding box with the generative language model to generate the plurality of synthetic text queries comprises:
processing, by the computing system, the image, the object label, and the ground truth bounding box with a chain-of-thought language model of the computing system to generate the plurality of synthetic text queries.

9. The computer-implemented method of claim 1, wherein the generative language model is prompted to generate one or more synthetic reference expressions based on one or more attributes of the ground truth bounding box, the one or more synthetic reference expressions comprising one or more terms that are different relative to the term from the object label.

10. The computer-implemented method of claim 1, wherein the generative language model is trained using chain-of-thought prompting.

11. The computer-implemented method of claim 1, wherein the generative language model is a pre-trained vision language model.

12. The computer-implemented method of claim 1, wherein the multimodal ROI model is a multitask unified model (MUM).

13. A computing system, comprising:
one or more processors; and
one or more non-transitory computer-readable media that collectively store instructions that, when executed by the one or more processors, cause the computing system to perform operations, the operations comprising:
receiving a multimodal search query comprising an image depicting a plurality of objects and a text query corresponding to one or more particular objects of the plurality of objects depicted in the image;
determining, by an object detection model, a plurality of bounding boxes for the image of the multimodal search query, each bounding box respectively identifying at least one of the plurality of objects depicted in the image;
processing, by a multimodal region-of-interest (ROI) model, the multimodal search query and the plurality of bounding boxes to generate a plurality of likelihood scores associated with the plurality of bounding boxes, each of the plurality of likelihood scores being descriptive of a predicted likelihood that a respective bounding box of the plurality of bounding boxes is associated with the text query;
determining one or more particular bounding boxes are associated with the one or more particular objects; and
determining, by a search engine, a plurality of search results based on the multimodal search query and the one or more particular bounding boxes.

14. The computing system of claim 13, wherein, to process the multimodal search query and the plurality of bounding boxes to generate the plurality of likelihood scores associated with the plurality of bounding boxes, the operations comprise:
for each bounding box of the plurality of bounding boxes:
processing, by the multimodal ROI model, the multimodal search query to generate one or more multimodal embeddings;
processing, by the multimodal ROI model, the bounding box to generate one or more bounding box embeddings;
processing, by the multimodal ROI model, the one or more multimodal embeddings and the one or more bounding box embeddings to determine a descriptive relationship between the text query of the multimodal search query and the bounding box; and
generating a likelihood score for the bounding box based on the descriptive relationship between the bounding box and the text query of the multimodal search query.

15. The computing system of claim 13, wherein, to determine the one or more particular bounding boxes are associated with the one or more particular objects, the operations comprise:
processing, by the multimodal ROI model, the plurality of likelihood scores associated with the plurality of bounding boxes to generate a ranked bounding box list, the ranked bounding box list comprising the plurality of bounding boxes ordered based on the plurality likelihood scores; and
determining one or more particular bounding boxes of the plurality of bounding boxes of the ranked bounding box list are associated with the one or more particular objects based on the plurality of likelihood scores.

16. The computing system of claim 13, wherein the multimodal ROI model is trained to determine whether the one or more particular bounding boxes are associated with the one or more particular objects based on training data generated by a generative language model.

17. The computing system of claim 16, wherein the generative language model comprises a pre-trained vision language model.

18. The computing system of claim 13, wherein the multimodal ROI model comprises a multitask unified model (MUM).

19. The computing system of claim 13, wherein, to determine the plurality of bounding boxes for the image of the multimodal search query, the operations comprise:
receiving, by the object detection model, the image of the multimodal search query;
processing, by the object detection model, the image of the multimodal search query to identify the plurality of objects depicted in the image; and
generating, by the object detection model, at least one bounding box identifying each object of the plurality of objects depicted in the image.

20. One or more non-transitory computer-readable media that collectively store instructions that, when executed by one or more processors of a computing system, cause the computing system to perform operations, the operations comprising:
obtaining an image depicting a plurality of objects, an object label associated with a particular object of the plurality of objects depicted in the image, and a ground truth bounding box associated with a position of the particular object within the image;
processing the image, the object label, and the ground truth bounding box with a vision language model to generate a plurality of synthetic text queries, each of the plurality of synthetic text queries referencing the particular object depicted in the image without using a term from the object label;
generating a training example comprising the image, the ground truth bounding box, and at least one of the plurality of synthetic text queries; and
training, with the training example, a multimodal region-of-interest (ROI) model of the computing system to determine one or more particular bounding boxes associated with the particular object depicted in the image.
